(19) United States
(12) Patent Application Publication
(10) Pub. No.: US 2016/0370974 A1
(43) Pub. Date: Dec. 22, 2016

(54) Causation of Expansion of a Supplemental Content Overlay

(71) Applicant: HERE Global B.V., LB Veldhoven (NL)

(72) Inventor: Leon Oliver STENNETH, Chicago, IL (US)

(21) Appl. No.: 14/746,812

(22) Filed: Jun. 22, 2015

(51) Int. Cl. G06F 3/0484; G06T 11/60; G06T 3/40; G06F 17/22

(52) U.S. Cl. CPC G06F 3/04842; G06F 17/2235; G06F 17/2247; G06T 11/60; G06T 3/40

(57) ABSTRACT

A method comprising causing display of a visual representation of content that comprises a link to supplemental content, receiving an indication of a selection initiation input associated with the link, determining that a first threshold duration has elapsed subsequent to the receipt of the selection initiation input, causing display of a supplemental content overlay that comprises a visual representation of a first portion of the supplemental content such that the supplemental content overlay has a first size, determining that a second threshold duration has elapsed subsequent to the receipt of the selection initiation input, and causing expansion of the supplemental content overlay such that the overlay has a second size that is larger than the first size, the supplemental content overlay comprising a visual representation of the first portion of the supplemental content and a second portion of the supplemental content is disclosed.

### TECHNICAL FIELD

The present application relates generally to causation of expansion of a supplemental content overlay.

### BACKGROUND

Electronic apparatuses are increasingly being utilized to browse and interact with information, such as webpages, maps, applications, and/or the like. In many circumstances, such information may be accessible by way of different webpages, different applications, and/or the like. As such, it may be desirable to allow a user to quickly and intuitively browse such information without unnecessarily interrupting or impeding the user's interactions.

### SUMMARY

Various aspects of example embodiments are set out in the summary, the drawings, the detailed description, and the claims.

One or more example embodiments may provide an apparatus, a computer readable medium, a non-transitory computer readable medium, a computer program product, and/or a method for causing display of a visual representation of content that comprises a link to supplemental content, receiving an indication of a selection initiation input associated with the link, determining that a first threshold duration has elapsed subsequent to the receipt of the selection initiation input absent receipt of a selection termination input, causing, in response to the determination that the first threshold duration has elapsed, display of a supplemental content overlay that comprises a visual representation of a first portion of the supplemental content such that the supplemental content overlay has a first size and overlays at least a portion of the content, determining that a second threshold duration has elapsed subsequent to the receipt of the selection initiation input absent receipt of a selection termination input, and causing, in response to the determination that the second threshold duration has elapsed, expansion of the supplemental content overlay such that the overlay has a second size that is larger than the first size, the supplemental content overlay comprising a visual representation of the first portion of the supplemental content and a second portion of the supplemental content.

One or more example embodiments may provide an apparatus, a computer readable medium, a computer program product, and/or a non-transitory computer readable medium having means for causing display of a visual representation of content that comprises a link to supplemental content, means for receiving an indication of a selection initiation input associated with the link, means for determining that a first threshold duration has elapsed subsequent to the receipt of the selection initiation input absent receipt of a selection termination input, means for causing, in response to the determination that the first threshold duration has elapsed, display of a supplemental content overlay that comprises a visual representation of a first portion of the supplemental content such that the supplemental content overlay has a first size and overlays at least a portion of the content, means for determining that a second threshold duration has elapsed subsequent to the receipt of the selection initiation input absent receipt of a selection termination input, and means for causing, in response to the determination that the second threshold duration has elapsed, expansion of the supplemental content overlay such that the overlay has a second size that is larger than the first size, the supplemental content overlay comprising a visual representation of the first portion of the supplemental content and a second portion of the supplemental content.

One or more example embodiments further perform receive the first portion of the supplemental content.

In at least one example embodiment, the causation of display of the supplemental content overlay that comprises the visual representation of the first portion of the supplemental content is based, at least in part, on the receipt of the first portion of the supplemental content.

One or more example embodiments further perform cause sending of a request for the first portion of the supplemental content to a separate apparatus.

In at least one example embodiment, the first portion of the supplemental content is received from the separate apparatus in response to the request for the first portion of the supplemental content.

One or more example embodiments further perform receive the second portion of the supplemental content.

In at least one example embodiment, the causation of display of the supplemental content overlay that comprises the visual representation of the first portion of the supplemental content and the second portion of the supplemental content is based, at least in part, on the receipt of the second portion of the supplemental content.

One or more example embodiments further perform cause sending of a request for the second portion of the supplemental content to a separate apparatus.

In at least one example embodiment, the second portion of the supplemental content is received from the separate apparatus in response to the request for the second portion of the supplemental content.

One or more example embodiments further perform receive an indication of a selection termination input associated with the link, and cause termination of display of the supplemental content overlay based, at least in part, on the selection termination input.

One or more example embodiments further perform receive an indication of another selection initiation input associated with the link, receive an indication of another selection termination input associated with the link prior to elapse of the first threshold duration, in response to the receipt of the other selection termination input prior to elapse of the first threshold duration, cause termination of display of the visual representation of the content, and cause display of a visual representation of at least a portion of the supplemental content.

One or more example embodiments further perform determine that a third threshold duration has elapsed subsequent to the receipt of the selection initiation input absent receipt of a selection termination input, and, in response to the determination that the third threshold duration has elapsed, cause expansion of the supplemental content overlay such that the overlay has a third size that is larger than the second size, the supplemental content overlay comprising a visual representation of the first portion of the supplemental content, the second portion of the supplemental content, and a third portion of the supplemental content.

In at least one example embodiment, the selection initiation input is a touch input, and the selection termination input indicates termination of the touch input.

In at least one example embodiment, the selection initiation input is a hover input, and the selection termination input indicates termination of the hover input.

In at least one example embodiment, the selection initiation input is a cursor input, and the selection termination input indicates termination of the cursor input.

In at least one example embodiment, the link to the supplemental content is caused to be displayed at a display position on a display, and the selection initiation input is at an input position that corresponds with the display position.

In at least one example embodiment, the visual representation of the content is a textual representation of the content.

In at least one example embodiment, the visual representation of the content comprises textual information.

In at least one example embodiment, the visual representation of the content is a graphical representation of the content.

In at least one example embodiment, the visual representation of the content comprises graphical information.

In at least one example embodiment, the supplemental content comprises textual information.

In at least one example embodiment, the supplemental content comprises graphical information.

In at least one example embodiment, the supplemental content comprises navigational information.

In at least one example embodiment, the link is a textual hyperlink.

In at least one example embodiment, the link is a graphical hyperlink.

In at least one example embodiment, the first portion of the supplemental content is a portion of textual information, and the second portion of the supplemental content is a different portion of the textual information.

In at least one example embodiment, the first portion of the supplemental content is a portion of textual information, and the second portion of the supplemental content is another portion of the textual information.

In at least one example embodiment, the first portion of the supplemental content is a portion of graphical information, and the second portion of the supplemental content is a different portion of the graphical information.

In at least one example embodiment, the first portion of the supplemental content is a portion of graphical information, and the second portion of the supplemental content is another portion of the graphical information.

In at least one example embodiment, the first portion of the supplemental content is a portion of navigational information, and the second portion of the supplemental content is a different portion of the navigational information.

In at least one example embodiment, the first portion of the supplemental content is a portion of navigational information, and the second portion of the supplemental content is another portion of the navigational information.

In at least one example embodiment, the portion of the navigational information comprises map information that is representative of a geographical region, and the other portion of the navigational information comprises additional map information that is representative of the geographical region.

In at least one example embodiment, the portion of the navigational information comprises map information that is representative of a geographical region, and the other portion of the navigational information comprises map information that is representative of a different geographical region that comprises the geographical region.

In at least one example embodiment, the size of the geographical region relative to the different geographical region is proportional to the first size of the supplemental content overlay relative to the second size of the supplemental content overlay.

One or more example embodiments further perform determine the first threshold duration based, at least in part, on a user input that indicates the first threshold duration.

One or more example embodiments further perform determine the first threshold duration based, at least in part, on at least one context associated with an apparatus that is caused to display the supplemental content overlay.

In at least one example embodiment, the context is a type of wireless connection associated with the apparatus.

In at least one example embodiment, the context is at least one of a time of day, a date, or a day of the week.

In at least one example embodiment, the context is a mode of transportation of a user of the apparatus.

In at least one example embodiment, the context is a location of the apparatus.

In at least one example embodiment, the context is at least one characteristic of a display comprised by the apparatus.

One or more example embodiments further perform determine the second threshold duration based, at least in part, on a user input that indicates the second threshold duration.

One or more example embodiments further perform determine the second threshold duration based, at least in part, on at least one context associated with an apparatus that is caused to display the supplemental content overlay.

One or more example embodiments further perform determine the first size of the supplemental content overlay based, at least in part, on a user input that indicates the first size of the supplemental content overlay.

One or more example embodiments further perform determine the first size of the supplemental content overlay based, at least in part, on at least one context associated with an apparatus that is caused to display the supplemental content overlay.

One or more example embodiments further perform determine the second size of the supplemental content overlay based, at least in part, on a user input that indicates the second size of the supplemental content overlay.

One or more example embodiments further perform determine the second size of the supplemental content overlay based, at least in part, on at least one context associated with an apparatus that is caused to display the supplemental content overlay.

One or more example embodiments further perform determine the first portion of the supplemental content based, at least in part, on a user input that indicates the first portion of the supplemental content.

One or more example embodiments further perform determine the first portion of the supplemental content based, at least in part, on at least one context associated with an apparatus that is caused to display the supplemental content overlay.

One or more example embodiments further perform determine the second portion of the supplemental content based, at least in part, on a user input that indicates the second portion of the supplemental content.

One or more example embodiments further perform determine the second portion of the supplemental content based, at least in part, on at least one context associated with an apparatus that is caused to display the supplemental content overlay.

### BRIEF DESCRIPTION OF THE DRAWINGS

For a more complete understanding of one or more example embodiments, reference is now made to the following descriptions taken in connection with the accompanying drawings in which:

FIG. 1 is a block diagram showing an apparatus according to at least one example embodiment;

FIG. 2 is a diagram illustrating apparatus communication according to at least one example embodiment;

FIGS. 3A-3F are diagrams illustrating a supplemental content overlay according to at least one example embodiment;

FIGS. 4A-4C are diagrams illustrating a supplemental content overlay according to at least one example embodiment;

FIG. 5 is a flow diagram illustrating activities associated with causation of display of a supplemental content overlay according to at least one example embodiment;

FIG. 6 is a flow diagram illustrating activities associated with termination of display of a supplemental content overlay according to at least one example embodiment;

FIG. 7 is a flow diagram illustrating activities associated with causation of display of a visual representation of at least a portion of supplemental content according to at least one example embodiment;

FIG. 8 is a flow diagram illustrating activities associated with determination of a threshold duration associated with a selection initiation input according to at least one example embodiment;

FIG. 9 is a flow diagram illustrating activities associated with determination of a size associated with a supplemental content overlay according to at least one example embodiment; and

FIG. 10 is a flow diagram illustrating activities associated with determination of a portion of supplemental content according to at least one example embodiment.

### DETAILED DESCRIPTION OF THE DRAWINGS

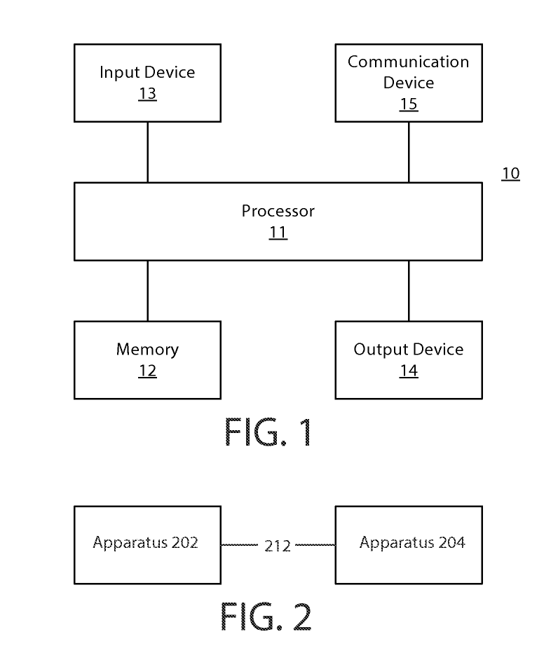

Various example embodiments and some of their potential advantages are understood by referring to FIGS. 1 through 10 of the drawings.

Some example embodiments will now further be described hereinafter with reference to the accompanying drawings, in which some, but not all, example embodiments are shown. One or more example embodiments may be embodied in many different forms and the claims should not be construed as being strictly limited to the example embodiments set forth herein; rather, these example embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with one or more example embodiments. Thus, use of any such terms should not be taken to limit the spirit and scope of example embodiments.

Additionally, as used herein, the term ‘circuitry’ refers to (a) hardware-only circuit implementations (e.g., implementations in analog circuitry, digital circuitry and/or any combination thereof); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that utilize software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit, an applications processor integrated circuit, a cellular network apparatus, other network apparatus, and/or other computing apparatus.

As defined herein, a “non-transitory computer readable medium,” which refers to a physical medium (e.g., volatile or non-volatile memory device), can be differentiated from a “transitory computer-readable medium,” which refers to an electromagnetic signal. In at least one example embodiment, a non-transitory computer readable medium is a tangible non-transitory computer readable medium.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from one or more example embodiments and, therefore, should not be taken to limit the scope of the claims. While electronic apparatus 10 is illustrated and will be hereinafter described for purposes of example, other types of electronic apparatuses may readily employ one or more example embodiments. Electronic apparatus 10 may be a personal digital assistant (PDAs), a pager, a mobile computer, a desktop computer, a television, a gaming apparatus, a laptop computer, a tablet computer, a media player, a wearable apparatus, a head mounted display, a camera, a video recorder, a mobile phone, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ one or more example embodiments regardless of any intent to provide mobility. In this regard, even though some example embodiments may be described in conjunction with mobile applications, it should be understood that such example embodiments may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises at least one processor, such as processor 11 and at least one memory, such as memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types (e.g., one or more standards in the Institute of Electrical and Electronics Engineers (IEEE) 802 family of wired and wireless standards). By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing one or more example embodiments including, for example, one or more of the functions described herein. For example, processor 11 may comprise means, such as a digital signal processor device, a microprocessor device, an analog to digital converter, a digital to analog converter, processing circuitry and other circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus, and/or the like. For example, the apparatus may send the information to a separate display, to a computer, to a laptop, to a mobile apparatus, and/or the like. For example, the apparatus may be a server that causes display of the information by way of sending the information to a client apparatus that displays the information. In this manner, causation of display of the information may comprise sending one or more messages to the separate apparatus that comprise the information, streaming the information to the separate apparatus, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In example embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element that is separate from processor 11 for processing data, such as image data. The camera module may provide data, such as image data, in one or more of various formats. In at least one example embodiment, the camera module comprises an encoder, a decoder, and/or the like for compressing and/or decompressing image data. The encoder and/or decoder may encode and/or decode according to a standard format, for example, a Joint Photographic Experts Group (JPEG) standard format.

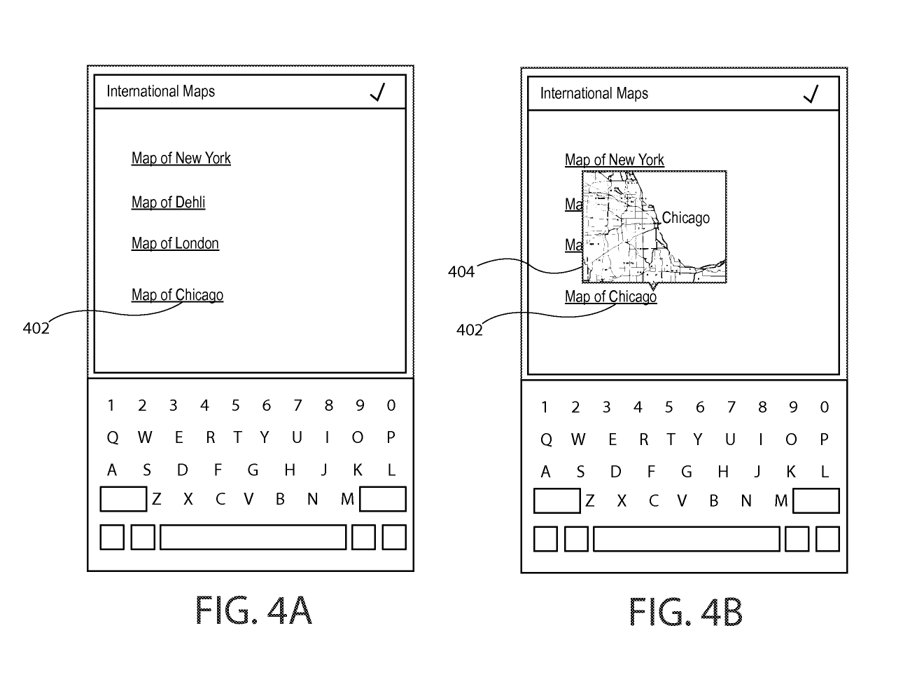

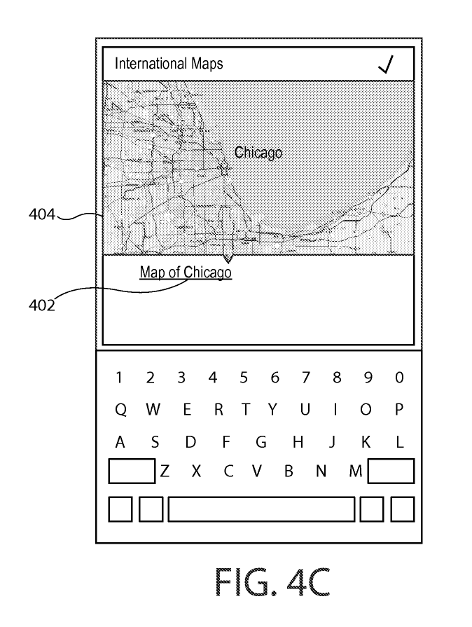

One or more example embodiments may include a geographic database. For example, the geographic database may comprise navigational information, map information, and/or the like associated the examples of FIG. 4A-4C, visual representations of navigational information, map information, and/or the like associated the examples of FIG. 4A-4C, and/or the like. For example, the geographic database may include node data records, road segment or link data records, point of interest (POI) data records, perspective image data records, video content data records, and other data records. More, fewer or different data records may be provided. In at least one example embodiment, the other data records include cartographic (“carto”) data records, routing data, and maneuver data. One or more portions, components, areas, layers, features, text, and/or symbols of the POI or event data may be stored in, linked to, and/or associated with one or more of these data records. For example, one or more portions of the POI, event data, or recorded route information may be matched with respective map or geographic records via position or GPS data associations (such as using known or future map matching or geo-coding techniques), for example.

In at least one example embodiment, the road segment data records are links or segments representing roads, streets, or paths, as may be used in the calculated route or recorded route information for determination of one or more personalized routes. The node data records may be end points corresponding to the respective links or segments of the road segment data records. The road link data records and the node data records may represent a road network, such as used by vehicles, cars, and/or other entities. Alternatively, the geographic database may contain path segment and node data records or other data that represent pedestrian paths or areas in addition to or instead of the vehicle road record data, for example.

The road/link segments and nodes may be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database may include data about the POIs and their respective locations in the POI data records. The geographic database may also include data about places, such as cities, towns, or other communities, and other geographic features, such as bodies of water, mountain ranges, etc. Such place or feature data may be part of the POI data or may be associated with POIs or POI data records (such as a data point used for displaying or representing a position of a city). In addition, the geographic database may include and/or be associated with event data (e.g., traffic incidents, constructions, scheduled events, unscheduled events, etc.) associated with the POI data records or other records of the geographic database.

The geographic database may be maintained by a content provider (e.g., a map developer) in association with a services platform. By way of example, the map developer may collect geographic data to generate and enhance the geographic database. There may be different ways used by the map developer to collect data. These ways may include obtaining data from other sources, such as municipalities or respective geographic authorities. In addition, the map developer may employ field personnel to travel by vehicle along roads throughout the geographic region to observe features and/or record information about them, for example. Also, remote sensing, such as aerial or satellite photography, may be used.

The geographic database may be a master geographic database stored in a format that facilitates updating, maintenance, and development. For example, the master geographic database or data in the master geographic database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation apparatuses or systems.

Geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation apparatus, such as by an end user apparatus, for example. The navigation-related functions may correspond to vehicle navigation, pedestrian navigation, or other types of navigation. The compilation to produce the end user databases may be performed by a party or entity separate from the map developer. For example, a customer of the map developer, such as a navigation apparatus developer or other end user apparatus developer, may perform compilation on a received geographic database in a delivery format to produce one or more compiled navigation databases.

As mentioned above, a server side geographic database may be a master geographic database, but in alternate embodiments, a client side geographic database may represent a compiled navigation database that may be used in or with an end user apparatus to provide navigation and/or map-related functions. For example, the geographic database may be used with an end user apparatus to provide an end user with navigation features. In such an example, the geographic database may be downloaded or stored on the end user apparatus, such as in one or more applications, or the end user apparatus may access the geographic database through a wireless or wired connection (such as via a server and/or a communication network), for example.

In at least one example embodiment, the end user apparatus is one of an in-vehicle navigation system, a personal navigation device (PND)/personal navigation apparatus, a portable navigation device/portable navigation apparatus, a cellular telephone, a mobile phone, a personal digital assistant (PDA), a watch, a camera, a computer, and/or other apparatuses that may perform navigation-related functions, such as digital routing and map display. In at least one example embodiment, the navigation apparatus is a cellular telephone. An end user may use the end user apparatus for navigation and map functions such as guidance and map display, for example, and for determination of one or more personalized routes or route segments based, at least in part, on one or more calculated and recorded routes, according to exemplary embodiments.

FIG. 2 is a diagram illustrating apparatus communication according to at least one example embodiment. The example of FIG. 2 is merely an example and does not limit the scope of the claims. For example, apparatus count may vary, apparatus configuration may vary, communication channels may vary, and/or the like.

In the example of FIG. 2, apparatus 202 is an electronic apparatus. An electronic apparatus may be an electronic apparatus that a user commonly utilizes during performance of various tasks, activities, and/or the like. For example, apparatus 202 may be an electronic apparatus that the user frequently utilizes to view information, to browse websites, to search for map information, and/or the like. For example, the electronic apparatus may be a phone, a tablet, a computer, a laptop, a near eye apparatus, and/or the like. In the example of FIG. 2, apparatus 204 is a separate apparatus, such as a separate electronic apparatus. For example, separate electronic apparatus may be used collaboratively with the electronic apparatus, in conjunction with the apparatus, in addition to the electronic apparatus, such that the separate apparatus is supporting one or more services associated with the electronic apparatus, and/or the like. In another example, the separate electronic apparatus may be utilized to store information associated with the electronic apparatus, to process information received from the electronic apparatus, and/or the like. For example, a separate electronic apparatus may be a phone, a tablet, a computer, a laptop, a server, a database, a cloud platform, a near eye apparatus, and/or the like. Although the aforementioned example describes apparatus 202 and apparatus 204 as distinct types of apparatuses, namely, an electronic apparatus and a separate electronic apparatus, in some circumstances, the apparatuses may both be electronic apparatuses, both be separate electronic apparatuses, and/or the like.

In the example of FIG. 2, apparatus 202 communicates with apparatus 204 by way of communication channel 212. For example, apparatus 202 may send information to apparatus 204 by way of communication channel 212, apparatus 202 may receive information sent from apparatus 204 by way of communication channel 212, and/or the like. A communication channel, for example, may be a channel utilized for sending and/or receiving of information, data, communications, and/or the like, between two or more apparatuses. It should be understood that, even though the example of FIG. 2 illustrates a direct communication channel between apparatus 202 and apparatus 204, there may be intermediate apparatuses that facilitate communication between apparatus 202 and apparatus 204. For example, there may be one or more routers, hubs, switches, gateways, and/or the like, that are utilized in the communication channels between apparatus 202 and apparatus 204. In addition, there may be other separate apparatuses that apparatus 202 and/or apparatus 204 are in communication with. For example, apparatus 202 and/or apparatus 204 may be in communication with another apparatus, a separate apparatus, a different apparatus, and/or the like.

In some circumstances, a user may desire to have collaboration between apparatuses, such as between an apparatus and a separate apparatus, based on their proximity with each other. For example, it may be intuitive for a user to manage collaboration between apparatuses that are local to each other. A plurality of apparatuses may be proximate to each other based, at least in part, on location, availability of local communication among the apparatuses, and/or the like. For example, if the apparatuses collaborate by way of low power radio frequency communication, a radio frequency communication, near field communication, inductive communication, electric field communication, Bluetooth communication, infrared communication, local area network communication, wireless local area network communication, local port communication, input/output port communication, and/or the like, the apparatuses may be considered to be proximate with each other based, at least in part, on availability of such proximity-based communication with each other. In at least one example embodiment, an apparatus may be a phone, a tablet, a computer, a display, a monitor, a head mounted display, a see through display, a wearable apparatus, a head worn apparatus, a hand worn apparatus, an electronic apparatus, a peripheral apparatus, a host apparatus, and/or the like. In at least one example embodiment, apparatuses communicate with each other. For example, an apparatus may be an apparatus that automatically communicates with another apparatus for purposes such as identifying the apparatus, synchronizing data, exchanging status information, and/or the like. In at least one example embodiment, an apparatus retains information associated with communication with a separate apparatus. For example, the apparatus may comprise information associated with identifying, communicating with, authenticating, performing authentication with, and/or the like, the separate apparatus. In this manner, the apparatus may be privileged to perform operations in conjunction with the separate apparatus that a different apparatus may lack the privilege to perform. For example, the apparatus may be privileged to access specific information that may be stored on the separate apparatus, cause the apparatus to perform one or more operations in response to a directive communicated to the separate apparatus, and/or the like.

In at least one example embodiment, communication based, at least in part, on short range communication is referred to as proximity-based communication. In at least one example embodiment, proximity-based communication relates to wireless communication that is associated with a short range, such as low power radio frequency communication, radio frequency communication, near field communication, inductive communication, electric field communication, Bluetooth communication, infrared communication, local area network communication, wireless local area network communication, local port communication, input/output port communication, and/or the like. In such an example, the exchange of information may be by way of the short range wireless communication between the apparatus and a separate apparatus, host apparatus, and/or the like.

In at least one example embodiment, a proximity-based communication channel is a low power radio frequency communication channel, a radio frequency communication channel, a near field communication channel, a wireless communication channel, a wireless local area network communication channel, a Bluetooth communication channel, an electric field communication channel, an inductive communication channel, an infrared communication channel, and/or the like. For example, as depicted in FIG. 2, apparatus 202 communicates with apparatus 204 by way of a communication channel 212. In the example of FIG. 2, communication channel 212 may be a low power radio frequency communication channel, a radio frequency communication channel, a near field communication channel, a wireless communication channel, a wireless local area network communication channel, a Bluetooth communication channel, an electric field communication channel, an inductive communication channel, an infrared communication channel, and/or the like.

In at least one example embodiment, an apparatus and a separate apparatus communicate by way of non-proximity-based communication channels. For example, as depicted in FIG. 2, apparatus 202 communicates with apparatus 204 by way of communication channel 212. In the example of FIG. 2, communication channel 212 may be a local area network communication channel, a wide area network communication channel, an internet communication channel, a cellular communication channel, and/or the like.

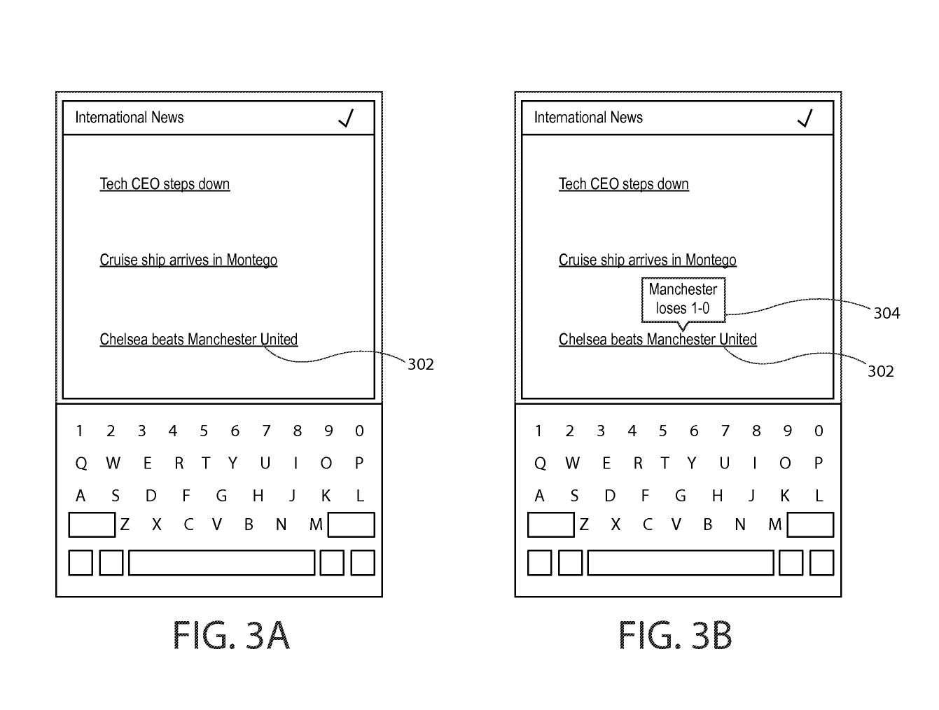

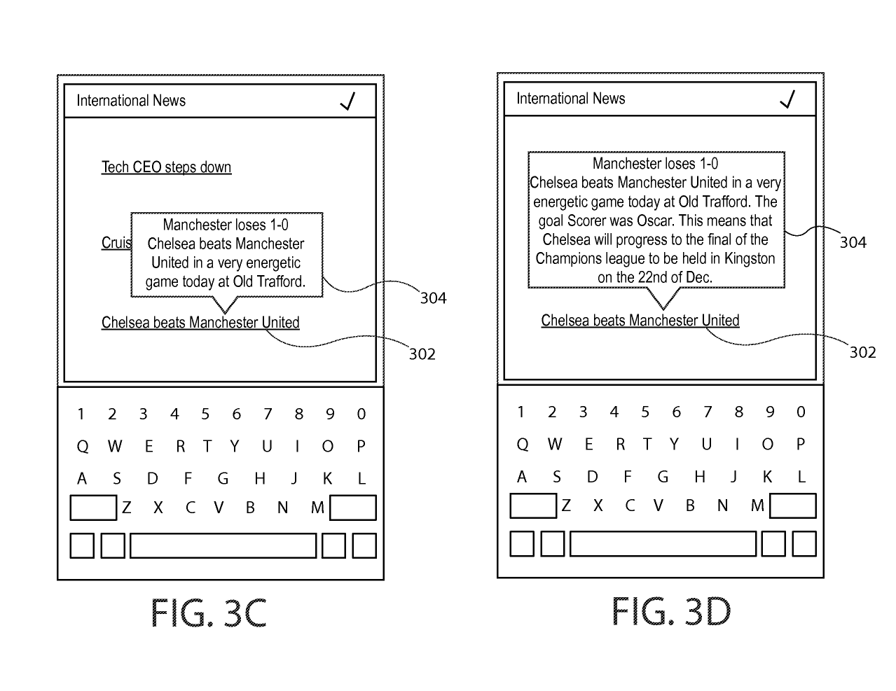

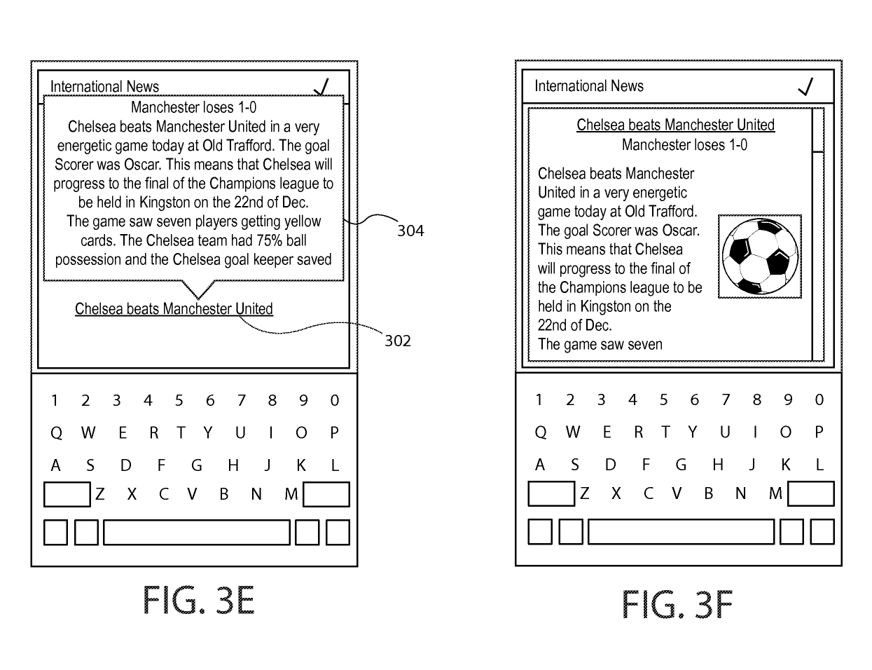

FIGS. 3A-3F are diagrams illustrating a supplemental content overlay according to at least one example embodiment. The examples of FIGS. 3A-3F are merely examples and do not limit the scope of the claims. For example, user interface may vary, visual representations may vary, content may vary, link type may vary, supplemental content may vary, supplemental content overlay may vary, and/or the like.

In many circumstances, a user of an electronic apparatus may desire to utilize the electronic apparatus to browse web-based content, interact with various information by way of one or more programs, and/or the like. For example, the user may desire to utilize the electronic apparatus to read news articles, view images, explore various map information, and/or the like. In at least one example embodiment, an apparatus causes display of a visual representation of content. The apparatus may display the visual representation of the content on a display comprised by the apparatus, may cause sending of information indicative of the content to a separate apparatus such that the separate apparatus is caused to display the visual representation of the content, and/or the like. In such an example embodiment, the content may be a webpage, a list of news articles, a collection of search results, a user interface of a program, and/or the like. In such an example embodiment, the content may comprise textual information, graphical information, and/or the like, such that the visual representation of the content comprises a textual representation of the textual content, a graphical representation graphical content, and/or the like. In many circumstances, the content may be associated with supplemental content. For example, the supplemental content may comprise textual information, graphical information, navigational information, map information, and/or the like. For example, the content may comprise a link to the supplemental content, such as a hyperlink, a location reference, and/or the like, to another webpage, a specific news article, a particular search result, a set of map information, another user interface of the program, and/or the like. In at least one example embodiment, the content comprises a link to supplemental content. In such an example embodiment, the link may be a hyperlink, a textual hyperlink, a graphical hyperlink, and/or the like.

FIG. 3A is a diagram illustrating a visual representation of content that comprises a link to supplemental content according to at least one example embodiment. The example of FIG. 3A depicts a visual representation of content that comprises link 302. As can be seen, the visual representation of the content comprises the header “International News,” and three links to three different news articles. In this manner, a user may desire to browse the various news stories offered under the “International News” header. For example, the user may be particularly interested in football, and may desire to perceive the supplemental content associated with link 302 regarding “Chelsea beats Manchester United.”

In some circumstances, a user viewing a visual representation of content that comprises a link to supplemental content may desire to view the supplemental content, to perceive a visual representation of the supplemental content, and/or the like. In such circumstances, the user may desire to view the supplemental content without navigating away from the content, to view the supplemental content and the content simultaneously, and/or the like. For example, the user may desire to quickly glimpse a portion of the supplemental content without having to load the entirety of the supplemental content, without being required to utilize a user interface element to return to the content that the user was previously browsing, and/or the like. In this manner, the user may perceive at least a portion of the supplemental content, such as a title of a news story, a part of the body of an article, a portion of a map, and/or the like. In at least one example embodiment, an apparatus receives an indication of a selection initiation input associated with the link. The selection initiation input may be a touch input, a hover input, a cursor input, and/or the like. For example, the link to the supplemental content may be caused to be displayed at a display position on a display, and the selection initiation input may be at an input position that corresponds with the display position. In another example, the selection initiation input may be a gaze input that indicates that the user's gaze position corresponds with the display position of the link to the supplemental content on the display.

As discussed previously, the user may desire to briefly perceive a portion of the supplemental content, to glance at a part of the supplemental content, and/or the like. As such, it may be desirable to configure an electronic apparatus such that a user of the electronic apparatus may indicate a desire to perceive the supplemental content associated with the link. For example, the user may perform a selection initiation input associated with the link and fail to perform a selection termination input for some period of time. For example, the selection initiation input may be a touch input, and the user may continue to hold the user's finger at the input position of the touch input. In such an example, the selection termination input may indicate termination of the touch input, such as the lifting of a stylus, a finger, and/or the like. In another example, the selection initiation input may be a hover input, and the user may continue to hover the user's finger at the input position of the hover input. In such an example, the selection termination input may indicate termination of the hover input, such as moving of a stylus, a finger, etc. away from the display. In yet another example, the selection initiation input may be a gaze input, and the user may continue to hold the user's gaze at the input position of the gaze input. In such an example embodiment, the selection termination input may indicate termination of the gaze input, such as the user averting the user's gaze, the user gazing at a different display position, and/or the like. In each of the aforementioned examples, the input may be held at approximately the input position of the respective input. For example, the input may be held within a threshold distance from the input position, the input may be held at a display position that corresponds with any portion of the link, and/or the like.

In this manner, the user may, for example, touch and hold the link for a predetermined amount of time in order to indicate the user's desire to glance at the supplemental content. In at least one example embodiment, an apparatus determines that a threshold duration has elapsed subsequent to the receipt of the selection initiation input absent receipt of a selection termination input. The threshold duration may, for example, be a period of time that a user holds a touch input that corresponds with a link to supplemental content, maintains a hover input over the link, gazes at the link, and/or the like, such that the user indicates the user's desire to perceive the supplemental content associated with the link. For example, prior to receipt of a selection termination input, the apparatus may determine that the threshold duration has elapsed subsequent to the receipt of the selection initiation input. In response to the determination that the threshold duration has elapsed, the apparatus may cause display of a supplemental content overlay. The supplemental content overlay may, for example, comprise a visual representation of a portion of the supplemental content. The portion of the supplemental content may be a portion of textual information, such as a headline, a paragraph, etc., a portion of graphical information, such as a cropped image, a low-resolution version of a video, and/or the like. In at least one example embodiment, the supplemental content overlay is displayed such that the supplemental content overlay has a size, a set of dimensions, etc. and overlays at least a portion of the content.

In order to facilitate the display of the portion of the supplemental content in the supplemental content overlay, the apparatus may receive an entirety of the supplemental content, the portion of the supplemental content, and/or the like from memory, a separate apparatus, a content server, and/or the like. In at least one example embodiment, an apparatus receives the portion of the supplemental content. In such an example embodiment, the causation of display of the supplemental content overlay that comprises the visual representation of the portion of the supplemental content may be based, at least in part, on the receipt of the portion of the supplemental content. In some circumstances, it may be desirable to receive only the portion of the supplemental content that is to be caused to be displayed in the supplemental content overlay. For example, the apparatus may receive such information by way of a metered wireless connection, an Internet connection with limited bandwidth, receipt of additional information may cause additional battery drain, and/or the like. As such, it may be desirable to receive only the portion of the supplemental content that is to be displayed in the supplemental content overlay. In at least one example embodiment, an apparatus causes sending of a request for the portion of the supplemental content to a separate apparatus, a content server, and/or the like. In such an example embodiment, the portion of the supplemental content may be received from the separate apparatus in response to the request for the portion of the supplemental content. For example, the apparatus may send a Hypertext Transfer Protocol (HTTP) range request that requests transfer of particular portions of the supplemental content from the separate apparatus to the apparatus. In such an example, the apparatus may send a request for a specific part of a file from the separate apparatus by way of utilizing a range request header. If the range is valid, the separate apparatus may send the requested portion of the file to the apparatus. By utilizing such range requests, byte-serving, and/or the like, the apparatus may request any portion of a particular resource, such as a webpage, a protected document format file, and/or the like. In this manner, the apparatus may request only the portion of the supplemental content such that the user of the apparatus may quickly perceive the title, the subject matter, the thesis, the summary, etc. of the supplemental content.

In some circumstances, the user may desire to discontinue viewing the portion of the supplemental content in the supplemental content overlay. In at least one example embodiment, an apparatus receives an indication of a selection termination input associated with the link, and causes termination of display of the supplemental content overlay based, at least in part, on the selection termination input. In such an example, the selection termination input may indicate termination of the touch input, such as the lifting of a stylus, a finger, and/or the like. In another example, the selection termination input may indicate termination of the hover input, such as moving of a stylus, a finger, etc. away from the display. In yet another example, the selection termination input may indicate termination of the gaze input, such as the user averting the user's gaze, the user gazing at a different display position, and/or the like.

FIG. 3B is a diagram illustrating a supplemental content overlay according to at least one example embodiment. The example of FIG. 3B depicts a visual representation of content that comprises link 302. As can be seen, the example of FIG. 3B corresponds with the example of FIG. 3A subsequent to display of supplemental content overlay 304, which overlays a portion of the visual representation of the content. In the example of FIG. 3B, the user indicated a desire to perceive a portion of the supplemental content associated with link 302 by way of a selection initiation input and allowance of the threshold duration to elapse absent performance of a selection termination input. As such, the apparatus was caused to display a portion of the supplemental content associated with link 302. In the example of FIG. 3B, the supplemental content comprises textual information, and the portion of the supplemental content is a sub-title, “Manchester loses 1-0,” of the news article titled “Chelsea beats Manchester United.”

As discussed previously, the user may desire to briefly perceive a portion of the supplemental content, to glance at a part of the supplemental content, and/or the like. In such circumstances, the user may desire to perceive more of the supplemental content, to view a larger portion of the supplemental content, and/or the like. As such, it may be desirable to configure an electronic apparatus such that a user of the electronic apparatus may indicate a desire to perceive additional supplemental content associated with the link. For example, the user may perform a selection initiation input associated with the link and fail to perform a selection termination input for some additional period of time. In this manner, the user may, for example, touch and hold the link for a predetermined amount of time in order to indicate the user's desire to perceive additional supplemental content.

For example, the user may touch and hold a link for a threshold duration such that a supplemental content overlay comprising a portion of the supplemental content is caused to be displayed. In such an example, the supplemental content overlay may be of a certain size, and may overlay at least a portion of the underlying content. In at least one example embodiment, an apparatus determines that another threshold duration has elapsed subsequent to the receipt of the selection initiation input absent receipt of a selection termination input. The other threshold duration may, for example, be a period of time that a user holds a touch input that corresponds with a link to supplemental content, maintains a hover input over the link, gazes at the link, and/or the like, such that the user indicates the user's desire to perceive additional supplemental content associated with the link. The other threshold duration may be measured from the selection initiation input, from the elapse of the threshold duration, and/or the like. For example, prior to receipt of a selection termination input, the apparatus may determine that the other threshold duration has elapsed subsequent to the receipt of the selection initiation input, subsequent to the elapse of the threshold duration, and/or the like. In response to the determination that the other threshold duration has elapsed, the apparatus may cause expansion of the supplemental content overlay such that the overlay has another size that is larger than the size. The supplemental content overlay may, for example, comprise a visual representation of the portion of the supplemental content and another portion of the supplemental content. The other portion of the supplemental content may be a portion of textual information, such as a headline, a paragraph, etc., a portion of graphical information, such as a less cropped image, a higher-resolution version of a video, and/or the like.

As discussed previously, in order to facilitate the display of the portion of the supplemental content and the other portion of the supplemental content in the supplemental content overlay, the apparatus may receive an entirety of the supplemental content, the other portion of the supplemental content, and/or the like from memory, a separate apparatus, a content server, and/or the like. In at least one example embodiment, an apparatus receives the other portion of the supplemental content. In such an example embodiment, the causation of display of the supplemental content overlay that comprises the visual representation of the portion of the supplemental content and the visual representation of the other portion of the supplemental content may be based, at least in part, on the receipt of the other portion of the supplemental content.

As discussed previously, in some circumstances, it may be desirable to receive the specific portions of the supplemental content that are displayed within the supplemental content overlay. In at least one example embodiment, an apparatus causes sending of a request for the other portion of the supplemental content to a separate apparatus, a content server, and/or the like. In such an example embodiment, the other portion of the supplemental content may be received from the separate apparatus in response to the request for the portion of the supplemental content. For example, the apparatus may send a Hypertext Transfer Protocol (HTTP) range request that requests transfer of particular portions of the supplemental content from the separate apparatus to the apparatus. In such an example, the apparatus may send a request for a specific part of a file from the separate apparatus by way of utilizing a range request header. If the range is valid, the separate apparatus may send the requested portion of the file to the apparatus. By utilizing such range requests, byte-serving, and/or the like, the apparatus may request any portion of a particular resource, such as a webpage, a protected document format file, and/or the like. In this manner, the apparatus may request only the portion of the supplemental content such that the user of the apparatus may quickly perceive the title, the subject matter, the thesis, the summary, etc. of the supplemental content. For example, the portion of the supplemental content may be a portion of textual information, and the other portion of the supplemental content may be a different portion of the textual information, another portion of the textual information, and/or the like. In another example, the portion of the supplemental content may be a portion of graphical information, and the other portion of the supplemental content may be a different portion of the graphical information, another portion of the graphical information, and/or the like.

FIG. 3C is a diagram illustrating a supplemental content overlay according to at least one example embodiment. The example of FIG. 3C depicts a visual representation of content that comprises link 302. As can be seen, the example of FIG. 3C corresponds with the example of FIG. 3B subsequent to expansion of supplemental content overlay 304, which overlays a larger portion of the visual representation of the content. In the example of FIG. 3C, the user indicated a desire to perceive an additional portion of the supplemental content associated with link 302, in comparison with the example of FIG. 3B, by way of a selection initiation input and allowance of another threshold duration to elapse absent performance of a selection termination input. As such, the apparatus was caused to expand the size of supplemental content overlay 304, and display another portion of the supplemental content associated with link 302 within supplemental content overlay 304. In the example of FIG. 3C, the supplemental content comprises textual information, and the portion of the supplemental content is a sub-title, “Manchester loses 1-0,” and first sentence, “Chelsea beats Manchester United in a very energetic game today at Old Trafford,” of the news article titled “Chelsea beats Manchester United.”

As discussed previously, the user may desire to perceive an increasing amount of the supplemental content based, at least in part, on a length of time that the user maintains an input associated with the link to the supplemental content. In such circumstances, the user may indicate the user's desire to perceive more of the supplemental content, to view a larger portion of the supplemental content, and/or the like by way of maintaining a touch input, holding a hover input, maintaining a gaze input, and/or the like associated with the link. As such, any number of threshold durations may be configured such that an increasing amount of the supplemental content is caused to be displayed in the supplemental content overlay. In this manner, rather than employing a lock-step approach, the threshold durations may be configured such that the portion of the supplemental content dynamically and fluidly increases and, in turn, the size of the supplemental content overlay dynamically and fluidly increases in order to contain the supplemental content.

FIG. 3D is a diagram illustrating a supplemental content overlay according to at least one example embodiment. The example of FIG. 3D depicts a visual representation of content that comprises link 302. As can be seen, the example of FIG. 3D corresponds with the example of FIG. 3C subsequent to expansion of supplemental content overlay 304, which overlays a larger portion of the visual representation of the content. In the example of FIG. 3D, the user indicated a desire to perceive an additional portion of the supplemental content associated with link 302, in comparison with the example of FIG. 3C, by way of a selection initiation input and allowance of another threshold duration to elapse absent performance of a selection termination input. As such, the apparatus was caused to expand the size of supplemental content overlay 304, and display another portion of the supplemental content associated with link 302 within supplemental content overlay 304. In the example of FIG. 3D, the supplemental content comprises textual information, and the portion of the supplemental content is a sub-title, “Manchester loses 1-0,” and first two sentences of the news article titled “Chelsea beats Manchester United.”

FIG. 3E is a diagram illustrating a supplemental content overlay according to at least one example embodiment. The example of FIG. 3E depicts a visual representation of content that comprises link 302. As can be seen, the example of FIG. 3E corresponds with the example of FIG. 3D subsequent to expansion of supplemental content overlay 304, which overlays a larger portion of the visual representation of the content. In the example of FIG. 3E, the user indicated a desire to perceive an additional portion of the supplemental content associated with link 302, in comparison with the example of FIG. 3D, by way of a selection initiation input and allowance of another threshold duration to elapse absent performance of a selection termination input. As such, the apparatus was caused to expand the size of supplemental content overlay 304, and display another portion of the supplemental content associated with link 302 within supplemental content overlay 304. In the example of FIG. 3E, the supplemental content comprises textual information, and the portion of the supplemental content is a sub-title, “Manchester loses 1-0,” and first three and a half sentences of the news article titled “Chelsea beats Manchester United.” As can be seen, supplemental content overlay 304 has been expanded such that supplemental content overlay 304 span the entirety of the width of the display, and spans the majority of the display area available between the header of the content and the link. In this manner, supplemental content overlay 304 fails to obscure the link.

In some circumstances, rather than viewing a portion of the supplemental content by way of a supplemental content overlay, the user may desire to navigate to a webpage, a program user interface screen, and/or the like associated with the supplemental content. For example, the user may simply click the link such that the supplemental content is requested and caused to be displayed such that the supplemental content replaces the previously viewed content. In at least one example embodiment, an apparatus receives an indication of a selection initiation input associated with the link, and receives an indication of a selection termination input associated with the link prior to elapse of a threshold duration. In response to the receipt of the selection termination input prior to elapse of the threshold duration, the apparatus may cause termination of display of the visual representation of the content, and cause display of a visual representation of at least a portion of the supplemental content. In this manner, the supplemental content may replace to the content, the visual representation of the supplemental content may replace the visual representation of the content, and/or the like.

FIG. 3F is a diagram illustrating a visual representation of at least a portion of the supplemental content according to at least one example embodiment. The example of FIG. 3F depicts a visual representation of the supplemental content associated with link 302 of FIGS. 3A-3E. In this manner, the example of FIG. 3F may correspond with any of FIGS. 3A-3E subsequent to receipt of a selection initiation input and receipt of a selection termination input prior to elapse of the threshold duration. In this manner, the user may have indicated a desire to browse to the webpage associated with the supplemental content, to switch to an application associated with the supplemental content, and/or the like. As can be seen, the visual representation of the supplemental content comprises the textual information displayed within supplemental content overlay 304 in each of FIGS. 3B-3E, as well as additional supplemental content, such as the graphical information depicting a football.

FIGS. 4A-4C are diagrams illustrating a supplemental content overlay according to at least one example embodiment. The examples of FIGS. 4A-4C are merely examples and do not limit the scope of the claims. For example, user interface may vary, visual representations may vary, content may vary, link type may vary, supplemental content may vary, supplemental content overlay may vary, and/or the like.

As discussed previously, in some circumstances, a user may desire to perceive an increasing amount of the supplemental content based, at least in part, on a length of time that the user maintains an input associated with the link to the supplemental content. In such circumstances, the user may indicate the user's desire to perceive more of the supplemental content, to view a larger portion of the supplemental content, and/or the like by way of maintaining a touch input, holding a hover input, maintaining a gaze input, and/or the like associated with the link. In some instances, the supplemental content may be map information, navigational information, and/or the like. In such circumstances, the apparatus may receive information indicative of a selection initiation input, and determine that a threshold duration has elapsed absent receipt of a selection termination input. In such an example, the apparatus may cause display of a supplemental content overlay that comprises a visual representation of map information, navigational information, and/or the like. The apparatus may subsequently determine that another threshold duration has elapsed subsequent to receipt of the selection initiation input, subsequent to determination that the threshold duration has elapsed, and/or the like, such that the apparatus causes expansion of the supplemental content overlay. In such an example, the expanded supplemental content overlay may comprise a visual representation of a portion of the supplemental content and another portion of the supplemental content. For example, the portion of the supplemental content may be a portion of map information, navigational information, and/or the like and the other portion of the supplemental content may be another portion, a different portion, etc. of the map information, the navigational information, and/or the like.

In some circumstances, as the supplemental content overlay expands, additional details, map information, etc. associated with a static geographical region may be represented. In this manner, as the supplemental content overlay is expanded in size, the dimensions of the visual representation of the geographical region may be expanded proportionally and, as the visual representation of the geographical region is displayed on a larger portion of the display, the amount of detail, the number of streets, etc. may be increased. For example, a portion of the supplemental content may comprise map information that is representative of a geographical region, and the other portion of the supplemental content may comprise additional map information that is representative of the geographical region. In this manner, the visual representation of the portion of the supplemental content may comprise a map with high level details, such as a name of a city, major highways, etc., and the visual representation of the portion of the supplemental content together with the other portion of the supplemental content may depict a map of the same geographical area, but with additional details, such as additional street names, points of interest, neighborhoods, and/or the like.

In some circumstances, as the supplemental content overlay expands, details, map information, etc. associated with an expanded geographical region may be represented. In this manner, as the supplemental content overlay is expanded in size, the size of the geographical region depicted in the visual representation of the supplemental content may be expanded proportionally. As such, as the supplemental content overlay is displayed on a larger portion of the display, the size of the geographical region depicted may be increased. For example, a portion of the supplemental content may comprise map information that is representative of a geographical region, and another portion of the supplemental content may comprise map information that is representative of a different geographical region that comprises the geographical region. In this manner, the geographical region depicted in the visual representation of the supplemental content may be expanded and the supplemental content overlay is expanded. In at least one example embodiment, the size of the geographical region relative to the different geographical region is proportional to the change in the size of the supplemental content overlay, to the expansion of the supplemental content overlay, and/or the like.

FIG. 4A is a diagram illustrating a visual representation of content that comprises a link to supplemental content according to at least one example embodiment. The example of FIG. 4A depicts a visual representation of content that comprises link 402. As can be seen, the visual representation of the content comprises the header “International Maps,” and four links to various map information, geographical regions, etc. In this manner, a user may desire to browse the various map information offered under the “International Map” header. For example, the user may be particularly interested in visiting Chicago, and may desire to perceive the supplemental content associated with link 402 regarding the “Map of Chicago.”

FIG. 4B is a diagram illustrating a supplemental content overlay according to at least one example embodiment. The example of FIG. 4B depicts a visual representation of content that comprises link 402. As can be seen, the example of FIG. 4B corresponds with the example of FIG. 4A subsequent to display of supplemental content overlay 404, which overlays a portion of the visual representation of the content. In the example of FIG. 4B, the user indicated a desire to perceive a portion of the supplemental content associated with link 402 by way of a selection initiation input and allowance of the threshold duration to elapse absent performance of a selection termination input. As such, the apparatus was caused to display a portion of the supplemental content associated with link 402. In the example of FIG. 4B, the supplemental content comprises map information associated with the geographical region surrounding Chicago, and the portion of the supplemental content is a high level visual representation of the city, the major thoroughfares, and/or the like.

FIG. 4C is a diagram illustrating a supplemental content overlay according to at least one example embodiment. The example of FIG. 4C depicts a visual representation of content that comprises link 302. As can be seen, the example of FIG. 4C corresponds with the example of FIG. 4B subsequent to expansion of supplemental content overlay 404, which overlays a larger portion of the visual representation of the content. In the example of FIG. 4C, the user indicated a desire to perceive an additional portion of the supplemental content associated with link 402, in comparison with the example of FIG. 4B, by way of a selection initiation input and allowance of another threshold duration to elapse absent performance of a selection termination input. As such, the apparatus was caused to expand the size of supplemental content overlay 404, and display another portion of the supplemental content associated with link 402 within supplemental content overlay 404. In the example of FIG. 4C, the supplemental content comprises map information, and the additional portion of the supplemental content is additional map information that labels various thoroughfares and smaller avenues, identifies neighborhoods within Chicago, marks various points of interest, and/or the like.

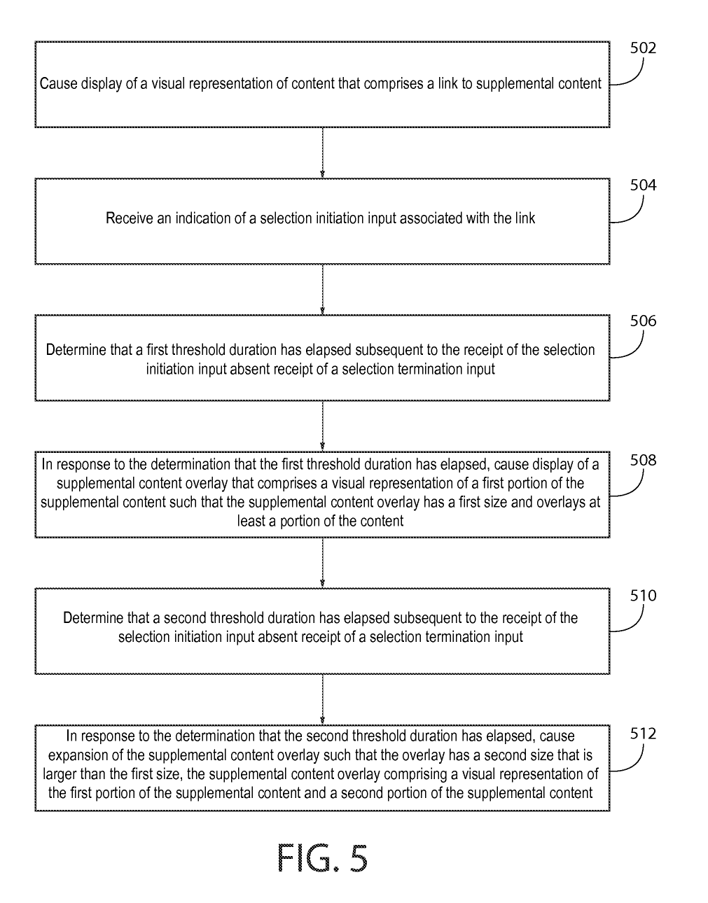

FIG. 5 is a flow diagram illustrating activities associated with causation of display of a supplemental content overlay according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 5.

At block 502, the apparatus causes display of a visual representation of content that comprises a link to supplemental content. The causation of display, the visual representation, the content, the link, and the supplemental content may be similar as described regarding FIGS. 3A-3F and FIGS. 4A-4C.

At block 504, the apparatus receives an indication of a selection initiation input associated with the link. The receipt and the selection initiation input may be similar as described regarding FIGS. 3A-3F and FIGS. 4A-4C.

At block 506, the apparatus determines that a first threshold duration has elapsed subsequent to the receipt of the selection initiation input absent receipt of a selection termination input. The determination, the first threshold duration, and the selection termination input may be similar as described regarding FIGS. 3A-3F and FIGS. 4A-4C.

At block 508, the apparatus causes display of a supplemental content overlay that comprises a visual representation of a first portion of the supplemental content such that the supplemental content overlay has a first size and overlays at least a portion of the content. In at least one example embodiment, the causation of display of the supplemental content overlay is in response to the determination that the first threshold duration has elapsed. The causation of display, the supplemental content, the visual representation, the first portion of the supplemental content, the first size, and the portion of the content may be similar as described regarding FIGS. 3A-3F and FIGS. 4A-4C.

At block 510, the apparatus determines that a second threshold duration has elapsed subsequent to the receipt of the selection initiation input absent receipt of a selection termination input. The determination, the second threshold duration, and the selection termination input may be similar as described regarding FIGS. 3A-3F and FIGS. 4A-4C.

At block 512, the apparatus causes expansion of the supplemental content overlay such that the overlay has a second size that is larger than the first size. In at least one example embodiment, the supplemental content overlay comprises a visual representation of the first portion of the supplemental content and a second portion of the supplemental content. In at least one example embodiment, the causation of expansion of the supplemental content overlay is in response to the determination that the second threshold duration has elapsed. The causation of expansion, the second size, the visual representation, and the second portion of the supplemental content may be similar as described regarding FIGS. 3A-3F and FIGS. 4A-4C.

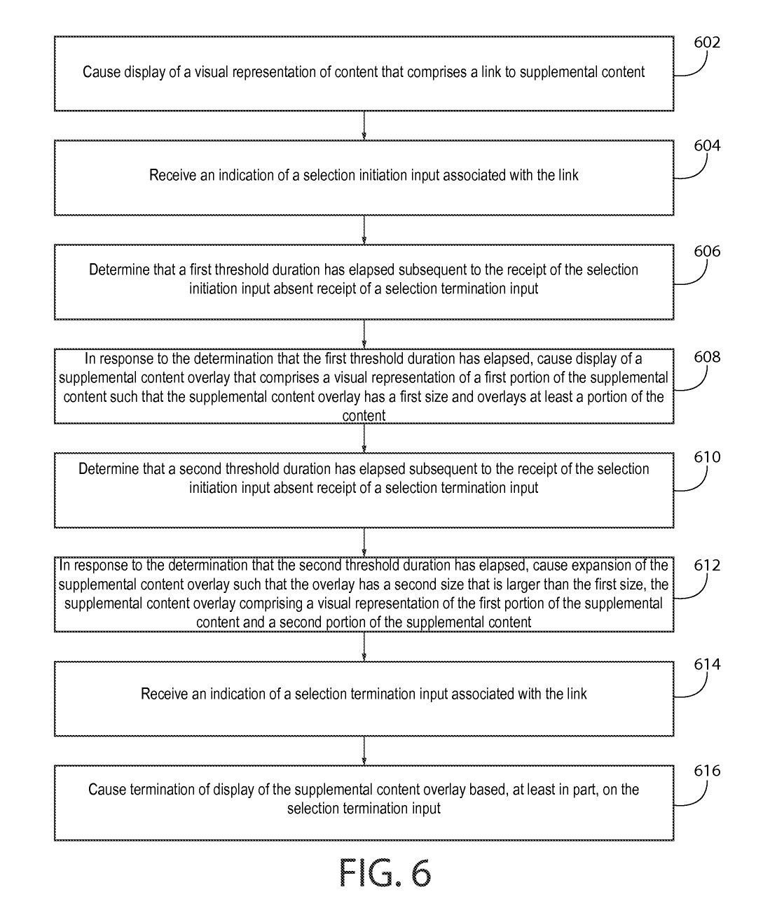

FIG. 6 is a flow diagram illustrating activities associated with termination of display of a supplemental content overlay according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 6.

As discussed previously, in some circumstances, it may be desirable to terminate display of a supplemental content overlay based, at least in part, on a selection termination input.

At block 602, the apparatus causes display of a visual representation of content that comprises a link to supplemental content. The causation of display, the visual representation, the content, the link, and the supplemental content may be similar as described regarding FIGS. 3A-3F and FIGS. 4A-4C.

At block 604, the apparatus receives an indication of a selection initiation input associated with the link. The receipt and the selection initiation input may be similar as described regarding FIGS. 3A-3F and FIGS. 4A-4C.

At block 606, the apparatus determines that a first threshold duration has elapsed subsequent to the receipt of the selection initiation input absent receipt of a selection termination input. The determination, the first threshold duration, and the selection termination input may be similar as described regarding FIGS. 3A-3F and FIGS. 4A-4C.

At block 608, the apparatus causes display of a supplemental content overlay that comprises a visual representation of a first portion of the supplemental content such that the supplemental content overlay has a first size and overlays at least a portion of the content. In at least one example embodiment, the causation of display of the supplemental content overlay is in response to the determination that the first threshold duration has elapsed. The causation of display, the supplemental content, the visual representation, the first portion of the supplemental content, the first size, and the portion of the content may be similar as described regarding FIGS. 3A-3F and FIGS. 4A-4C.

At block 610, the apparatus determines that a second threshold duration has elapsed subsequent to the receipt of the selection initiation input absent receipt of a selection termination input. The determination, the second threshold duration, and the selection termination input may be similar as described regarding FIGS. 3A-3F and FIGS. 4A-4C.

At block 612, the apparatus causes expansion of the supplemental content overlay such that the overlay has a second size that is larger than the first size. In at least one example embodiment, the supplemental content overlay comprises a visual representation of the first portion of the supplemental content and a second portion of the supplemental content. In at least one example embodiment, the causation of expansion of the supplemental content overlay is in response to the determination that the second threshold duration has elapsed. The causation of expansion, the second size, the visual representation, and the second portion of the supplemental content may be similar as described regarding FIGS. 3A-3F and FIGS. 4A-4C.

At block 614, the apparatus receives an indication of a selection termination input associated with the link. The receipt and the selection termination input may be similar as described regarding FIGS. 3A-3F and FIGS. 4A-4C.

At block 616, the apparatus causes termination of display of the supplemental content overlay based, at least in part, on the selection termination input. The causation of termination of display may be similar as described regarding FIGS. 3A-3F and FIGS. 4A-4C.

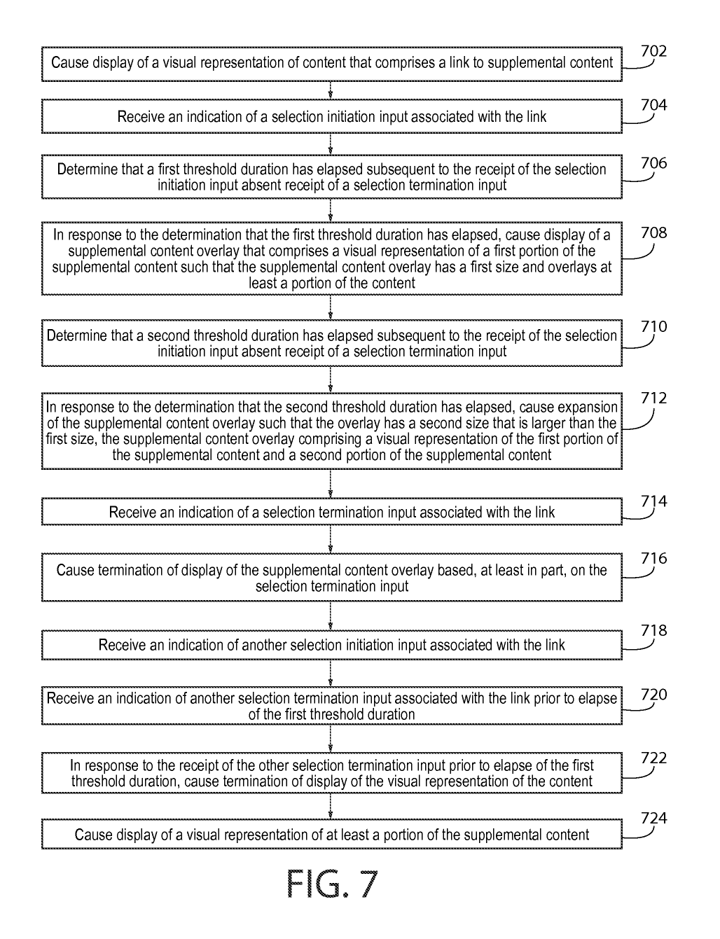

FIG. 7 is a flow diagram illustrating activities associated with causation of display of a visual representation of at least a portion of supplemental content according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 7.

As discussed previously, in some circumstances, it may be desirable to cause display of a visual representation of at least a portion of the supplemental content in response to receipt of a selection termination input prior to elapse of a threshold duration.

At block 702, the apparatus causes display of a visual representation of content that comprises a link to supplemental content. The causation of display, the visual representation, the content, the link, and the supplemental content may be similar as described regarding FIGS. 3A-3F and FIGS. 4A-4C.

At block 704, the apparatus receives an indication of a selection initiation input associated with the link. The receipt and the selection initiation input may be similar as described regarding FIGS. 3A-3F and FIGS. 4A-4C.

At block 706, the apparatus determines that a first threshold duration has elapsed subsequent to the receipt of the selection initiation input absent receipt of a selection termination input. The determination, the first threshold duration, and the selection termination input may be similar as described regarding FIGS. 3A-3F and FIGS. 4A-4C.

At block 708, the apparatus causes display of a supplemental content overlay that comprises a visual representation of a first portion of the supplemental content such that the supplemental content overlay has a first size and overlays at least a portion of the content. In at least one example embodiment, the causation of display of the supplemental content overlay is in response to the determination that the first threshold duration has elapsed. The causation of display, the supplemental content, the visual representation, the first portion of the supplemental content, the first size, and the portion of the content may be similar as described regarding FIGS. 3A-3F and FIGS. 4A-4C.

At block 710, the apparatus determines that a second threshold duration has elapsed subsequent to the receipt of the selection initiation input absent receipt of a selection termination input. The determination, the second threshold duration, and the selection termination input may be similar as described regarding FIGS. 3A-3F and FIGS. 4A-4C.

At block 712, the apparatus causes expansion of the supplemental content overlay such that the overlay has a second size that is larger than the first size. In at least one example embodiment, the supplemental content overlay comprises a visual representation of the first portion of the supplemental content and a second portion of the supplemental content. In at least one example embodiment, the causation of expansion of the supplemental content overlay is in response to the determination that the second threshold duration has elapsed. The causation of expansion, the second size, the visual representation, and the second portion of the supplemental content may be similar as described regarding FIGS. 3A-3F and FIGS. 4A-4C.

At block 714, the apparatus receives an indication of a selection termination input associated with the link. The receipt and the selection termination input may be similar as described regarding FIGS. 3A-3F and FIGS. 4A-4C.

At block 716, the apparatus causes termination of display of the supplemental content overlay based, at least in part, on the selection termination input. The causation of termination of display may be similar as described regarding FIGS. 3A-3F and FIGS. 4A-4C.

At block 718, the apparatus receives an indication of another selection initiation input associated with the link. The receipt and the other selection initiation input may be similar as described regarding FIGS. 3A-3F and FIGS. 4A-4C.

At block 720, the apparatus receives an indication of another selection termination input associated with the link prior to elapse of the first threshold duration. The receipt and the other selection termination input may be similar as described regarding FIGS. 3A-3F and FIGS. 4A-4C.

At block 722, the apparatus causes termination of display of the visual representation of the content. In at least one example embodiment, the termination of display of the visual representation of the content is in response to the receipt of the other selection termination input prior to elapse of the first threshold duration. The causation of termination of display may be similar as described regarding FIGS. 3A-3F and FIGS. 4A-4C.

At block 724, the apparatus causes display of a visual representation of at least a portion of the supplemental content. In at least one example embodiment, the causation of display of the visual representation of the portion of the supplemental content is in response to the receipt of the other selection termination input prior to elapse of the first threshold duration. The causation of display, the visual representation, and the portion of the supplemental content may be similar as described regarding FIGS. 3A-3F and FIGS. 4A-4C.

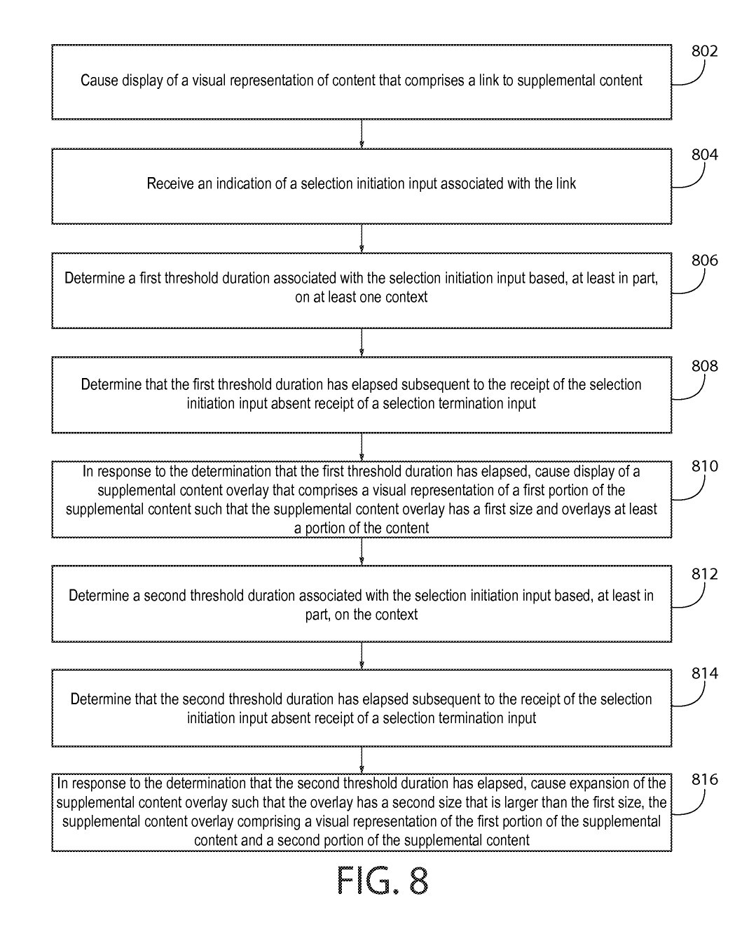

FIG. 8 is a flow diagram illustrating activities associated with determination of a threshold duration associated with a selection initiation input according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 8.

In some circumstances, a user may desire to set a specific threshold duration, to control the length of time required to cause display of a supplemental content overlay, to modify the duration of time subsequent to receipt of the selection initiation input prior to expansion of a supplemental content overlay, and/or the like. In at least one example embodiment, an apparatus determines a threshold duration based, at least in part, on a user input that indicates the threshold duration. For example, the user may set a particular value for a threshold duration, may import a set of threshold durations from memory, a separate apparatus, etc., and/or the like. In this manner, a user may personalize the threshold duration as the user desires. In some circumstances, the threshold duration may be learned over time, modified based, at least in part, on prior selection initiation inputs and/or selection termination inputs, and/or the like. For example, if the user commonly holds a selection initiation input through several enlargement iterations, it may be inferred that the user desires to view larger supplemental content overlays that comprise a larger portion of the supplemental content. As such, it may be desirable to shorten one or more threshold durations such that the user can more quickly view the larger supplemental content overlay that comprises a larger portion of the supplemental content. In another example, if the user commonly holds a selection initiation input through only one enlargement iteration, no enlargement iterations, and/or the like, it may be inferred that the user desires to view smaller supplemental content overlays that comprise a smaller portion of the supplemental content. As such, it may be desirable to lengthen one or more threshold durations such that the user can view the smaller supplemental content overlay that comprises a smaller portion of the supplemental content without having to worry about postponing the selection termination input for too long.

In some circumstances, it may be desirable to determine at least one threshold duration in a dynamic fashion. For example, a user utilizing an electronic apparatus to browse content, supplemental content, and/or the like may desire to utilize various threshold durations based, at least in part, on a context of the user, a context of the user's electronic apparatus, and/or the like. In at least one example embodiment, the apparatus determines a threshold duration based, at least in part, on at least one context associated with an apparatus, at least one context associated with the user of the apparatus, and/or the like. For example, the context may be a user context, and apparatus context, and/or the like.

In at least one example embodiment, the context is a type of wireless connection associated with the apparatus. For example, if the apparatus is associated with a high bandwidth connection via a wireless network, the threshold duration may be shorter than if the apparatus is associated with a lower bandwidth cellular data connection. In such an example, it may be inferred that the user is stationary if the user's apparatus is connected to a wireless network. In such circumstances, the user may be able to perceive additional portions of the supplemental content in rapid succession, the user may be able to safely direct the user's attention to the expanding supplemental content overlay, and/or the like. As such, the threshold duration may be a shorter threshold duration that results in faster expansion of the supplemental content overlay. It may also be inferred that, in situations in which the user's apparatus is connected to a cellular data network, that the user is mobile, walking, driving, and/or the like. In such circumstances, the user may be unable to perceive additional portions of the supplemental content in rapid succession, the user may be unable to safely direct the user's attention to the rapidly expanding supplemental content overlay, and/or the like. As such, the threshold duration may be a longer threshold duration that results in slower expansion of the supplemental content overlay. However, in some circumstances, it may be desirable for the first threshold duration, the threshold duration that controls the initial display of the supplemental content overlay, to display quickly in circumstances in which the user can divert minimal attention to the user's apparatus, and for subsequent threshold durations to be longer.

Similarly, the context may be a mode of transportation of the user. For modes of transportation that are more conducive to allowing a user to browse various content, such as bus, train, subway, etc., the threshold duration may be a shorter threshold duration that results in faster expansion of the supplemental content overlay. For modes of transportation that are less conducive to allowing a user to browse various content, such as driving, cycling, walking, etc., the threshold duration may be a longer threshold duration that results in slower expansion of the supplemental content overlay. However, in some circumstances, it may be desirable for the first threshold duration, the threshold duration that controls the initial display of the supplemental content overlay, to display quickly in circumstances in which the user can divert minimal attention to the user's apparatus, and for subsequent threshold durations to be longer.

In some circumstances, the context may be a location of the user, of the user's apparatus, and/or the like. For locations that are more conducive to allowing a user to browse various content, such as at a café, at a residence, etc., the threshold duration may be a shorter threshold duration that results in faster expansion of the supplemental content overlay. For locations that are less conducive to allowing a user to browse various content, such as in a meeting, in a movie theater, at work, etc., the threshold duration may be a longer threshold duration that results in slower expansion of the supplemental content overlay. However, in some circumstances, it may be desirable for the first threshold duration, the threshold duration that controls the initial display of the supplemental content overlay, to display quickly in circumstances in which the user can divert minimal attention to the user's apparatus, and for subsequent threshold durations to be longer.

In some circumstances, the context may be a time of day, a date, a day of the week, and/or the like. For times that are more conducive to allowing a user to browse various content, such as at night, on the weekend, etc., the threshold duration may be a shorter threshold duration that results in faster expansion of the supplemental content overlay. For times that are less conducive to allowing a user to browse various content, such as on Christmas, on a workday, during work hours, etc., the threshold duration may be a longer threshold duration that results in slower expansion of the supplemental content overlay. However, in some circumstances, it may be desirable for the first threshold duration, the threshold duration that controls the initial display of the supplemental content overlay, to display quickly in circumstances in which the user can divert minimal attention to the user's apparatus, and for subsequent threshold durations to be longer.

In some circumstances, the context may be at least one characteristic of a display comprised by the apparatus, such as dimensions, resolution, and/or the like. For apparatuses with a larger display, a higher resolution display, etc., the threshold duration may be a shorter threshold duration that results in faster expansion of the supplemental content overlay that more quickly fills the display. For apparatuses with smaller displays, lower resolution displays, etc. the threshold duration may be a longer threshold duration that results in slower expansion of the supplemental content overlay. However, in some circumstances, it may be desirable for the first threshold duration, the threshold duration that controls the initial display of the supplemental content overlay, to display quickly regardless of the size of the display, the resolution of the display, etc., and for subsequent threshold durations to be longer.

In some circumstances, the context may be an application, a webpage, etc. that a user is interacting with. For example, an application associated with the display of textual information, such as various news articles, may be associated with a threshold duration that is longer than a threshold duration of an application associated with the display of graphical information, such as images of an image gallery. In such an example, a supplemental content overlay that comprises textual information may expand more slowly such that the user may have time to read and process the expanding amount of textual information being displayed. In such an example, a supplemental content overlay that comprises graphical information may expand at a faster rate as the user may be able to more quickly perceive and analyze the graphical information.

At block 802, the apparatus causes display of a visual representation of content that comprises a link to supplemental content. The causation of display, the visual representation, the content, the link, and the supplemental content may be similar as described regarding FIGS. 3A-3F and FIGS. 4A-4C.

At block 804, the apparatus receives an indication of a selection initiation input associated with the link. The receipt and the selection initiation input may be similar as described regarding FIGS. 3A-3F and FIGS. 4A-4C.

At block 806, the apparatus determines a first threshold duration associated with the selection initiation input based, at least in part, on at least one context. The determination, the first threshold duration, and the context may be similar as described regarding FIGS. 3A-3F and FIGS. 4A-4C.

At block 808, the apparatus determines that the first threshold duration has elapsed subsequent to the receipt of the selection initiation input absent receipt of a selection termination input. The determination and the selection termination input may be similar as described regarding FIGS. 3A-3F and FIGS. 4A-4C.

At block 810, the apparatus causes display of a supplemental content overlay that comprises a visual representation of a first portion of the supplemental content such that the supplemental content overlay has a first size and overlays at least a portion of the content. In at least one example embodiment, the causation of display of the supplemental content overlay is in response to the determination that the first threshold duration has elapsed. The causation of display, the supplemental content, the visual representation, the first portion of the supplemental content, the first size, and the portion of the content may be similar as described regarding FIGS. 3A-3F and FIGS. 4A-4C.

At block 812, the apparatus determines a second threshold duration associated with the selection initiation input based, at least in part, on the context. The determination and the second threshold duration may be similar as described regarding FIGS. 3A-3F and FIGS. 4A-4C.

At block 814, the apparatus determines that the second threshold duration has elapsed subsequent to the receipt of the selection initiation input absent receipt of a selection termination input. The determination and the selection termination input may be similar as described regarding FIGS. 3A-3F and FIGS. 4A-4C.

At block 816, the apparatus causes expansion of the supplemental content overlay such that the overlay has a second size that is larger than the first size. In at least one example embodiment, the supplemental content overlay comprises a visual representation of the first portion of the supplemental content and a second portion of the supplemental content. In at least one example embodiment, the causation of expansion of the supplemental content overlay is in response to the determination that the second threshold duration has elapsed. The causation of expansion, the second size, the visual representation, and the second portion of the supplemental content may be similar as described regarding FIGS. 3A-3F and FIGS. 4A-4C.

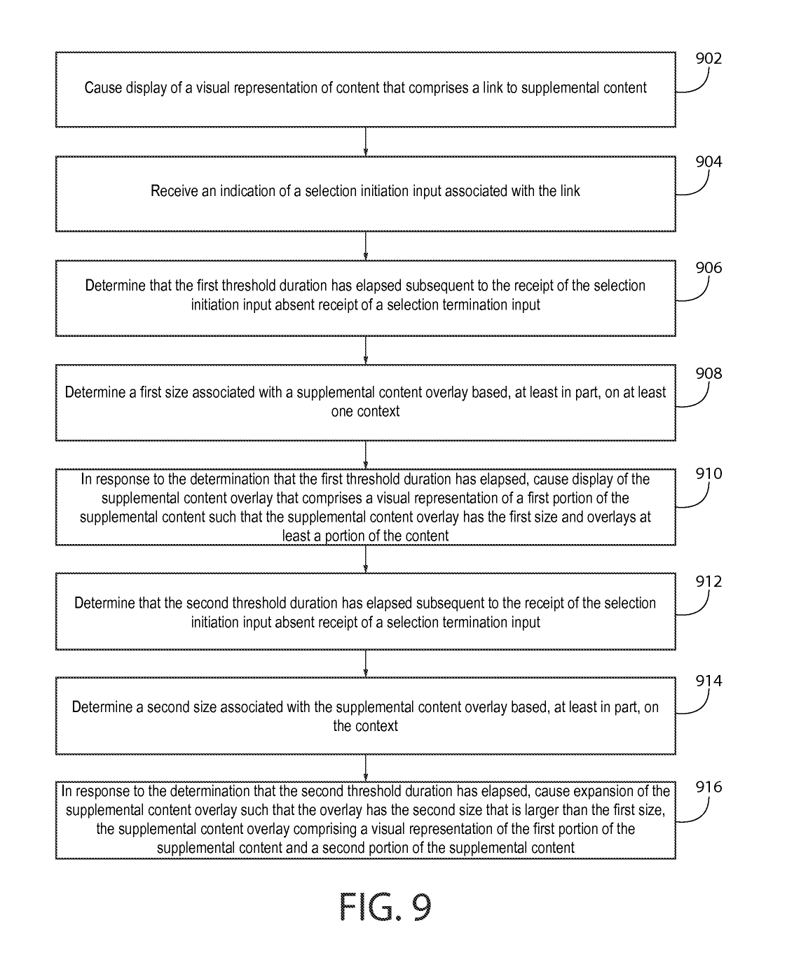

FIG. 9 is a flow diagram illustrating activities associated with determination of a size associated with a supplemental content overlay according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 9.

In some circumstances, a user may desire to set the various sizes of a supplemental content overlay, to control the initial size of the supplemental content overlay, to modify an expanded size of the supplemental content overlay, and/or the like. In at least one example embodiment, an apparatus determines a size of a supplemental content overlay based, at least in part, on a user input that indicates the size of a supplemental content overlay. For example, the user may set a particular value for a size of a supplemental content overlay, may import a set of sizes associated with a supplemental content overlay from memory, a separate apparatus, etc., and/or the like.

In some circumstances, it may be desirable to determine at least one size of a supplemental content overlay in a dynamic fashion. For example, a user utilizing an electronic apparatus to browse content, supplemental content, and/or the like may desire to utilize various sizes of a supplemental content overlay based, at least in part, on a context of the user, a context of the user's electronic apparatus, and/or the like. In at least one example embodiment, the apparatus determines a size of a supplemental content overlay based, at least in part, on at least one context associated with an apparatus, at least one context associated with the user of the apparatus, and/or the like. For example, the context may be a user context, and apparatus context, and/or the like.

In at least one example embodiment, the context is a type of wireless connection associated with the apparatus. For example, if the apparatus is associated with a high bandwidth connection via a wireless network, the size of a supplemental content overlay may be larger than if the apparatus is associated with a lower bandwidth cellular data connection. In such an example, it may be inferred that the user is stationary if the user's apparatus is connected to a wireless network. In such circumstances, the user may be able to perceive larger portions of the supplemental content, the user may be able to safely direct the user's attention to the larger supplemental content overlay, and/or the like. As such, the size of a supplemental content overlay may be a larger such that additional supplemental content may be displayed within the supplemental content overlay. It may also be inferred that, in situations in which the user's apparatus is connected to a cellular data network, that the user is mobile, walking, driving, and/or the like. In such circumstances, the user may be unable to perceive the larger portions of the supplemental content, the user may be unable to safely direct the user's attention to the additional supplemental content in the supplemental content overlay, and/or the like. As such, the size of a supplemental content overlay may be smaller, such that less supplemental content is displayed within the supplemental content overlay.

Similarly, the context may be a mode of transportation of the user. For modes of transportation that are more conducive to allowing a user to browse various content, such as bus, train, subway, etc., the size of a supplemental content overlay may be larger. For modes of transportation that are less conducive to allowing a user to browse various content, such as driving, cycling, walking, etc., the size of a supplemental content overlay may be smaller.

In some circumstances, the context may be a location of the user, of the user's apparatus, and/or the like. For locations that are more conducive to allowing a user to browse various content, such as at a café, at a residence, etc., the size of a supplemental content overlay may be larger. For locations that are less conducive to allowing a user to browse various content, such as in a meeting, in a movie theater, at work, etc., the size of a supplemental content overlay may be smaller.

In some circumstances, the context may be a time of day, a date, a day of the week, and/or the like. For times that are more conducive to allowing a user to browse various content, such as at night, on the weekend, etc., the size of a supplemental content overlay may be larger. For times that are less conducive to allowing a user to browse various content, such as on Christmas, on a workday, during work hours, etc., the size of a supplemental content overlay may be smaller.

In some circumstances, the context may be at least one characteristic of a display comprised by the apparatus, such as dimensions, resolution, and/or the like. For apparatuses with a larger display, a higher resolution display, etc., the size of a supplemental content overlay may be smaller such that the supplemental content overlay is clearly legible by the user, but obstructs a smaller portion of the underlying content. For apparatuses with smaller displays, lower resolution displays, etc. the size of a supplemental content overlay may be larger such that the supplemental content is sufficiently dimensioned to allow a user to easily perceive the supplemental content.

In some circumstances, the size of the supplemental content overlay may be constrained by one or more characteristics of a display comprised by the apparatus, such as dimensions, resolution, and/or the like. In such an example, the supplemental content overlay may be enlarged to a maximum size that is determined based, at least in part, on at least one characteristic of the display. For example, the supplemental content overlay may have a maximum width (in inches, pixels, etc.), a maximum height (in inches, pixels, etc.), and/or the like. In this manner, once the supplemental content overlay has been expanded to the maximum size, the supplemental content overlay may be unable to expand further.

In some circumstances, the context may be an application, a webpage, etc. that a user is interacting with. For example, an application associated with the display of textual information, such as various news articles, the size of a supplemental content overlay may be larger than the size of a supplemental content overlay of an application associated with the display of graphical information, such as images of an image gallery. In such an example, a supplemental content overlay that comprises textual information may benefit from a larger supplemental content overlay such that a user may be able to easily read the textual information being displayed. In such an example, a supplemental content overlay that comprises graphical information may be, in general, easily perceivable despite being displayed in a smaller supplemental content overlay.

At block 902, the apparatus causes display of a visual representation of content that comprises a link to supplemental content. The causation of display, the visual representation, the content, the link, and the supplemental content may be similar as described regarding FIGS. 3A-3F and FIGS. 4A-4C.

At block 904, the apparatus receives an indication of a selection initiation input associated with the link. The receipt and the selection initiation input may be similar as described regarding FIGS. 3A-3F and FIGS. 4A-4C.

At block 906, the apparatus determines that a first threshold duration has elapsed subsequent to the receipt of the selection initiation input absent receipt of a selection termination input. The determination, the first threshold duration, and the selection termination input may be similar as described regarding FIGS. 3A-3F and FIGS. 4A-4C.

At block 908, the apparatus determines a first size associated with a supplemental content overlay based, at least in part, on at least one context. The determination, the first size, the supplemental content overlay, and the context may be similar as described regarding FIGS. 3A-3F and FIGS. 4A-4C.

At block 910, the apparatus causes display of the supplemental content overlay that comprises a visual representation of a first portion of the supplemental content such that the supplemental content overlay has the first size and overlays at least a portion of the content. In at least one example embodiment, the causation of display of the supplemental content overlay is in response to the determination that the first threshold duration has elapsed. The causation of display, the visual representation, the first portion of the supplemental content, and the portion of the content may be similar as described regarding FIGS. 3A-3F and FIGS. 4A-4C.

At block 912, the apparatus determines that a second threshold duration has elapsed subsequent to the receipt of the selection initiation input absent receipt of a selection termination input. The determination, the second threshold duration, and the selection termination input may be similar as described regarding FIGS. 3A-3F and FIGS. 4A-4C.

At block 914, the apparatus determines a second size associated with the supplemental content overlay based, at least in part, on the context. The determination and the second size may be similar as described regarding FIGS. 3A-3F and FIGS. 4A-4C.

At block 916, the apparatus causes expansion of the supplemental content overlay such that the overlay has the second size that is larger than the first size. In at least one example embodiment, the supplemental content overlay comprises a visual representation of the first portion of the supplemental content and a second portion of the supplemental content. In at least one example embodiment, the causation of expansion of the supplemental content overlay is in response to the determination that the second threshold duration has elapsed. The causation of expansion, the visual representation, and the second portion of the supplemental content may be similar as described regarding FIGS. 3A-3F and FIGS. 4A-4C.

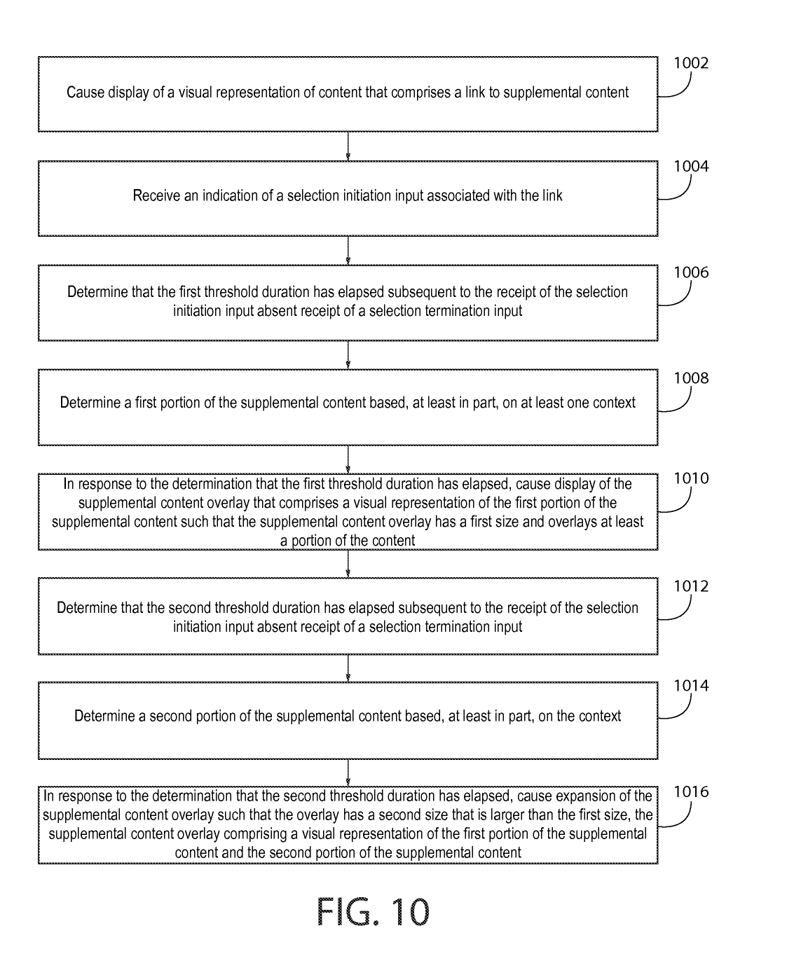

FIG. 10 is a flow diagram illustrating activities associated with determination of a portion of supplemental content according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 10.

In some circumstances, a user may desire to set a particular portion of the supplemental content to display, to control the initial portion of the supplemental content in the supplemental content overlay, to modify the additional portion of the supplemental content depicted within an expanded supplemental content overlay, and/or the like. In at least one example embodiment, an apparatus determines a portion of supplemental content based, at least in part, on a user input that indicates the portion of the supplemental content. For example, the user may set a particular value for a portion of supplemental content, may indicate a particular HTTP range request to be performed, and/or the like.

In some circumstances, it may be desirable to determine a portion of supplemental content in a dynamic fashion. For example, a user utilizing an electronic apparatus to browse content, supplemental content, and/or the like may desire to perceive various amounts of supplemental content, various portions of the supplemental content, etc. based, at least in part, on a context of the user, a context of the user's electronic apparatus, and/or the like. In at least one example embodiment, the apparatus determines a portion of supplemental content based, at least in part, on at least one context associated with an apparatus, at least one context associated with the user of the apparatus, and/or the like. For example, the context may be a user context, and apparatus context, and/or the like.

In at least one example embodiment, the context is a type of wireless connection associated with the apparatus. For example, if the apparatus is associated with a high bandwidth connection via a wireless network, the portion of the supplemental content may be larger than if the apparatus is associated with a lower bandwidth cellular data connection. In such an example, it may be inferred that the user is stationary if the user's apparatus is connected to a wireless network. In such circumstances, the user may be able to perceive larger portions of the supplemental content, the user may be able to safely direct the user's attention to a title and a body paragraph of a news article, and/or the like. As such, the portion of the supplemental content may be a larger such that additional supplemental content may be displayed within the supplemental content overlay. It may also be inferred that, in situations in which the user's apparatus is connected to a cellular data network, that the user is mobile, walking, driving, and/or the like. In such circumstances, the user may be unable to perceive the larger portions of the supplemental content, the user may be unable to safely direct the user's attention to any details comprised in a news article beyond the title of the news article, and/or the like. As such, the portion of the supplemental content may be smaller, such that less supplemental content is displayed within the supplemental content overlay.

Similarly, the context may be a mode of transportation of the user. For modes of transportation that are more conducive to allowing a user to browse various content, such as bus, train, subway, etc., the portion of the supplemental content may be larger. For modes of transportation that are less conducive to allowing a user to browse various content, such as driving, cycling, walking, etc., the portion of the supplemental content may be smaller.

In some circumstances, the context may be a location of the user, of the user's apparatus, and/or the like. For locations that are more conducive to allowing a user to browse various content, such as at a café, at a residence, etc., the portion of the supplemental content may be larger. For locations that are less conducive to allowing a user to browse various content, such as in a meeting, in a movie theater, at work, etc., the portion of the supplemental content may be smaller.

In some circumstances, the context may be a time of day, a date, a day of the week, and/or the like. For times that are more conducive to allowing a user to browse various content, such as at night, on the weekend, etc., the portion of the supplemental content may be larger. For times that are less conducive to allowing a user to browse various content, such as on Christmas, on a workday, during work hours, etc., the portion of the supplemental content may be smaller.

In some circumstances, the context may be at least one characteristic of a display comprised by the apparatus, such as dimensions, resolution, and/or the like. For apparatuses with a larger display, a higher resolution display, etc., the portion of the supplemental content may be larger such that the user may read additional textual information, perceive additional map information, and/or the like. For apparatuses with smaller displays, lower resolution displays, etc. the portion of supplemental content may be smaller such that the supplemental content is sufficiently dimensioned to allow a user to easily perceive the supplemental content by way of the limited display.

In some circumstances, the context may be an application, a webpage, etc. that a user is interacting with. For example, in an application associated with the display of textual information, such as various news articles, the portion of the supplemental content may differ from the portion of the supplemental content in an application associated with the display of graphical information, such as images of an image gallery. In such an example, a supplemental content overlay that comprises textual information may comprise a portion of the textual information that conveys a headline to the user, a summary of a news article to the user, and/or the like. In such an example, a supplemental content overlay that comprises graphical information may comprise a portion of the graphical information that conveys a thumbnail of the graphical information, a cropped version of the graphical information, and/or the like.

At block 1002, the apparatus causes display of a visual representation of content that comprises a link to supplemental content. The causation of display, the visual representation, the content, the link, and the supplemental content may be similar as described regarding FIGS. 3A-3F and FIGS. 4A-4C.

At block 1004, the apparatus receives an indication of a selection initiation input associated with the link. The receipt and the selection initiation input may be similar as described regarding FIGS. 3A-3F and FIGS. 4A-4C.

At block 1006, the apparatus determines that a first threshold duration has elapsed subsequent to the receipt of the selection initiation input absent receipt of a selection termination input. The determination, the first threshold duration, and the selection termination input may be similar as described regarding FIGS. 3A-3F and FIGS. 4A-4C.

At block 1008, the apparatus determines a first portion of the supplemental content based, at least in part, on at least one context. The determination, the first portion of the supplemental content, and the context may be similar as described regarding FIGS. 3A-3F and FIGS. 4A-4C.

At block 1010, the apparatus causes display of the supplemental content overlay that comprises a visual representation of a first portion of the supplemental content such that the supplemental content overlay has a first size and overlays at least a portion of the content. In at least one example embodiment, the causation of display of the supplemental content overlay is in response to the determination that the first threshold duration has elapsed. The causation of display, the first size, the visual representation, the first portion of the supplemental content, and the portion of the content may be similar as described regarding FIGS. 3A-3F and FIGS. 4A-4C.

At block 1012, the apparatus determines that a second threshold duration has elapsed subsequent to the receipt of the selection initiation input absent receipt of a selection termination input. The determination, the second threshold duration, and the selection termination input may be similar as described regarding FIGS. 3A-3F and FIGS. 4A-4C.

At block 1014, the apparatus determines a second portion of the supplemental content based, at least in part, on the context. The determination and the second portion of the supplemental content may be similar as described regarding FIGS. 3A-3F and FIGS. 4A-4C.

At block 1016, the apparatus causes expansion of the supplemental content overlay such that the overlay has a second size that is larger than the first size. In at least one example embodiment, the supplemental content overlay comprises a visual representation of the first portion of the supplemental content and a second portion of the supplemental content. In at least one example embodiment, the causation of expansion of the supplemental content overlay is in response to the determination that the second threshold duration has elapsed. The causation of expansion, the second size, the visual representation, and the second portion of the supplemental content may be similar as described regarding FIGS. 3A-3F and FIGS. 4A-4C.

One or more example embodiments may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various computer-readable media.

If desired, the different functions discussed herein may be performed in a different order and/or concurrently with each other. For example, blocks 718, 720, 722, and 724 of FIG. 7 may be performed before block 702 of FIG. 7. Furthermore, if desired, one or more of the above-described functions may be optional or may be combined. For example, block 806 and/or block 812 of FIG. 8 may be optional and/or combined with block 804 of FIG. 8.

Although various aspects of the present subject matter are set out in the independent claims, other aspects of the present subject matter comprise other combinations of features from the described example embodiments and/or the dependent claims with the features of the independent claims, and not solely the combinations explicitly set out in the claims.

It is also noted herein that while the above describes example embodiments, these descriptions should not be viewed in a limiting sense. Rather, there are variations and modifications which may be made without departing from the scope of the present subject matter.

What is claimed is:

1. An apparatus, comprising:
at least one processor;
at least one memory including computer program code, the memory and the computer program code configured to, working with the processor, cause the apparatus to perform at least the following:
cause display of a visual representation of content that comprises a link to supplemental content;
receive an indication of a selection initiation input associated with the link;
determine that a first threshold duration has elapsed subsequent to the receipt of the selection initiation input absent receipt of a selection termination input;
in response to the determination that the first threshold duration has elapsed, cause display of a supplemental content overlay that comprises a visual representation of a first portion of the supplemental content such that the supplemental content overlay has a first size and overlays at least a portion of the content;
determine that a second threshold duration has elapsed subsequent to the receipt of the selection initiation input absent receipt of a selection termination input; and
in response to the determination that the second threshold duration has elapsed, cause expansion of the supplemental content overlay such that the overlay has a second size that is larger than the first size, the supplemental content overlay comprising a visual representation of the first portion of the supplemental content and a second portion of the supplemental content.

2. The apparatus of claim 1, wherein the memory includes computer program code configured to, working with the processor, cause the apparatus to perform:
cause sending of a request for the first portion of the supplemental content to a separate apparatus; and
in response to the request for the first portion of the supplemental content, receive the first portion of the supplemental content from the separate apparatus, wherein the causation of display of the supplemental content overlay that comprises the visual representation of the first portion of the supplemental content is based, at least in part, on the receipt of the first portion of the supplemental content.

3. The apparatus of claim 1, wherein the memory includes computer program code configured to, working with the processor, cause the apparatus to perform:
cause sending of a request for the second portion of the supplemental content to a separate apparatus; and
in response to the request for the second portion of the supplemental content, receive the second portion of the supplemental content from the separate apparatus, wherein the causation of display of the supplemental content overlay that comprises the visual representation of the first portion of the supplemental content and the second portion of the supplemental content is based, at least in part, on the receipt of the second portion of the supplemental content.

4. The apparatus of claim 1, wherein the memory includes computer program code configured to, working with the processor, cause the apparatus to perform:
receive an indication of a selection termination input associated with the link; and
cause termination of display of the supplemental content overlay based, at least in part, on the selection termination input.

5. The apparatus of claim 1, wherein the memory includes computer program code configured to, working with the processor, cause the apparatus to perform:
receive an indication of another selection initiation input associated with the link;
receive an indication of another selection termination input associated with the link prior to elapse of the first threshold duration;
in response to the receipt of the other selection termination input prior to elapse of the first threshold duration, cause termination of display of the visual representation of the content; and
cause display of a visual representation of at least a portion of the supplemental content.

6. The apparatus of claim 1, wherein the memory includes computer program code configured to, working with the processor, cause the apparatus to perform:
determine that a third threshold duration has elapsed subsequent to the receipt of the selection initiation input absent receipt of a selection termination input; and
in response to the determination that the third threshold duration has elapsed, cause expansion of the supplemental content overlay such that the overlay has a third size that is larger than the second size, the supplemental content overlay comprising a visual representation of the first portion of the supplemental content, the second portion of the supplemental content, and a third portion of the supplemental content.

7. The apparatus of claim 1, wherein the first portion of the supplemental content is a portion of navigational information, and the second portion of the supplemental content is another portion of the navigational information.

8. The apparatus of claim 7, wherein the portion of the navigational information comprises map information that is representative of a geographical region, and the other portion of the navigational information comprises additional map information that is representative of the geographical region.

9. The apparatus of claim 7, wherein the portion of the navigational information comprises map information that is representative of a geographical region, and the other portion of the navigational information comprises map information that is representative of a different geographical region that comprises the geographical region.

10. A method comprising:
causing display of a visual representation of content that comprises a link to supplemental content;
receiving an indication of a selection initiation input associated with the link;
determining that a first threshold duration has elapsed subsequent to the receipt of the selection initiation input absent receipt of a selection termination input;
in response to the determination that the first threshold duration has elapsed, causing display of a supplemental content overlay that comprises a visual representation of a first portion of the supplemental content such that the supplemental content overlay has a first size and overlays at least a portion of the content;
determining that a second threshold duration has elapsed subsequent to the receipt of the selection initiation input absent receipt of a selection termination input; and
in response to the determination that the second threshold duration has elapsed, causing expansion of the supplemental content overlay such that the overlay has a second size that is larger than the first size, the supplemental content overlay comprising a visual representation of the first portion of the supplemental content and a second portion of the supplemental content.

11. The method of claim 10, further comprising:
receiving an indication of a selection termination input associated with the link; and
causing termination of display of the supplemental content overlay based, at least in part, on the selection termination input.

12. The method of claim 10, further comprising:
receiving an indication of another selection initiation input associated with the link;
receiving an indication of another selection termination input associated with the link prior to elapse of the first threshold duration;
in response to the receipt of the other selection termination input prior to elapse of the first threshold duration, causing termination of display of the visual representation of the content; and
causing display of a visual representation of at least a portion of the supplemental content.

13. The method of claim 10, further comprising:
determining that a third threshold duration has elapsed subsequent to the receipt of the selection initiation input absent receipt of a selection termination input; and
in response to the determination that the third threshold duration has elapsed, causing expansion of the supplemental content overlay such that the overlay has a third size that is larger than the second size, the supplemental content overlay comprising a visual representation of the first portion of the supplemental content, the second portion of the supplemental content, and a third portion of the supplemental content.

14. The method of claim 10, wherein the first portion of the supplemental content is a portion of navigational information, and the second portion of the supplemental content is another portion of the navigational information.

15. The method of claim 14, wherein the portion of the navigational information comprises map information that is representative of a geographical region, and the other portion of the navigational information comprises additional map information that is representative of the geographical region.

16. The method of claim 14, wherein the portion of the navigational information comprises map information that is representative of a geographical region, and the other portion of the navigational information comprises map information that is representative of a different geographical region that comprises the geographical region.

17. At least one computer-readable medium encoded with instructions that, when executed by a processor, perform:
cause display of a visual representation of content that comprises a link to supplemental content;
receive an indication of a selection initiation input associated with the link;
determine that a first threshold duration has elapsed subsequent to the receipt of the selection initiation input absent receipt of a selection termination input;
in response to the determination that the first threshold duration has elapsed, cause display of a supplemental content overlay that comprises a visual representation of a first portion of the supplemental content such that the supplemental content overlay has a first size and overlays at least a portion of the content;
determine that a second threshold duration has elapsed subsequent to the receipt of the selection initiation input absent receipt of a selection termination input; and
in response to the determination that the second threshold duration has elapsed, cause expansion of the supplemental content overlay such that the overlay has a second size that is larger than the first size, the supplemental content overlay comprising a visual representation of the first portion of the supplemental content and a second portion of the supplemental content.

18. The medium of claim 17, further encoded with instructions that, when executed by a processor, perform:
cause sending of a request for the first portion of the supplemental content to a separate apparatus; and
in response to the request for the first portion of the supplemental content, receive the first portion of the supplemental content from the separate apparatus, wherein the causation of display of the supplemental content overlay that comprises the visual representation of the first portion of the supplemental content is based, at least in part, on the receipt of the first portion of the supplemental content.

19. The medium of claim 18, further encoded with instructions that, when executed by a processor, perform:
cause sending of a request for the second portion of the supplemental content to a separate apparatus; and
in response to the request for the second portion of the supplemental content, receive the second portion of the supplemental content from the separate apparatus, wherein the causation of display of the supplemental content overlay that comprises the visual representation of the first portion of the supplemental content and the second portion of the supplemental content is based, at least in part, on the receipt of the second portion of the supplemental content.

20. The medium of claim 18, further encoded with instructions that, when executed by a processor, perform:
receive an indication of a selection termination input associated with the link; and
cause termination of display of the supplemental content overlay based, at least in part, on the selection termination input.
